(19) United States
(12) Patent Application Publication
(10) Pub. No.: US 2021/0215607 A1
(43) Pub. Date: Jul. 15, 2021

(54) NUCLEIC ACID SEQUENCING CARTRIDGES, PACKAGED DEVICES, AND SYSTEMS

(71) Applicant: Pacific Biosciences of California, Inc., Menlo Park, CA (US)

(72) Inventors: Russell BERMAN, San Carlos, CA (US); Jaime Juan BENITEZ-MARZAN, Fremont, CA (US); Natasha POPOVICH, Belmont, CA (US); Aaron RULISON, Los Altos, CA (US); Ravi SAXENA, Millbrae, CA (US)

(73) Assignee: Pacific Biosciences of California, Inc., Menlo Park, CA (US)

(21) Appl. No.: 17/149,455

(22) Filed: Jan. 14, 2021

Related U.S. Application Data
(60) Provisional application No. 62/961,175, filed on Jan. 14, 2020.

(51) Int. Cl. G01N 21/64

(52) U.S. Cl. CPC G01N 21/6452; G01N 2201/0873; G01N 21/6428

(57) ABSTRACT

Provided herein are cartridges, packaged devices, and systems for improved nucleic acid sequencing. The cartridges, devices, and systems include a highly multiplexed optical chip comprising a plurality of nanoscale reaction regions that is configured to perform and report nucleic acid sequencing reactions. The chips are, in some embodiments, packaged for use in analytical nucleic acid sequencing reactions. The chips may be attached to a printed circuit board, may be surrounded by a protective enclosure, may include a flow cell, and may include optical features to minimize or block photobleaching of the sequencing reagents and background fluorescent signals. Also provided are analytical systems for nucleic acid sequencing that comprise the disclosed cartridges and packaged devices. The systems comprise an analytical instrument with electronic, optical, mechanical, fluidic, and/or thermal connectors designed to interact with the corresponding connectors on an associated cartridge or packaged device in a highly precise but reversible manner.

### CROSS-REFERENCE TO RELATED APPLICATIONS

This application claims the benefit of U.S. Provisional Application No. 62/961,175, filed on Jan. 14, 2020, the disclosure of which is incorporated herein by reference in its entirety.

### STATEMENT REGARDING FEDERALLY SPONSORED RESEARCH

Not Applicable.

### BACKGROUND OF THE INVENTION

As multiplexed analytical systems continue to be miniaturized in size, expanded in scale, and increased in power, the need to develop improved systems capable of such functionality becomes more important. Furthermore, many analytical techniques are initially available only at high cost, and they can only be performed in controlled, laboratory settings by highly-trained laboratory technicians. For example, nucleic acid sequencing was originally possible only in research laboratories, using techniques and equipment that were expensive and complicated to perform. Advances in nucleic acid sequencing technologies have brought down the cost per unit sequenced and have therefore greatly expanded the availability of sequence data, but the sequencing reactions must still typically be performed in sophisticated laboratories with expensive equipment by highly trained individuals.

Many optical analytical techniques likewise rely on sophisticated equipment and expertise, and they are therefore also expensive and complicated to scale up. For example, conventional optical systems employ complex optical trains that direct, focus, filter, split, separate, and detect light to and from the sample materials. Such systems typically employ an assortment of different optical elements to direct, modify, and otherwise manipulate light entering and leaving a reaction site. Such systems are typically complex and costly and tend to have significant space requirements. For example, typical systems employ mirrors and prisms in directing light from its source to a desired destination. Additionally, such systems may include light-splitting optics such as beam-splitting prisms or diffraction gratings to generate two or more beams from a single original beam.

Integrated optical systems for nucleic acid sequencing have recently become available that enable large-scale, even genomic-scale, nucleic acid sequencing to be performed with standardized and commercially available laboratory equipment. See, for example, U.S. Patent Publication Nos. 2012/0014837, 2012/0021525, 2012/0019828, and 2016/0061740. Such equipment continues to remain relatively large and expensive, however, thus limiting the extent of adoption of the technology.

There is, therefore, a continuing need to decrease the size and cost of integrated devices and systems for nucleic acid sequencing, and thus to increase the availability of this technology on a wider scale and at lower cost.

### BRIEF SUMMARY OF THE INVENTION

The present disclosure addresses these and other needs by providing in one aspect integrated cartridges for nucleic acid sequencing, the cartridges comprising:

a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions;
   wherein the multiplexed optical chip is surrounded by a protective enclosure.

In some embodiments, the cartridge further comprises a connector element in electronic contact with the optical detector, optionally wherein the protective enclosure comprises at least one aperture for access to the connector element. In some embodiments, the cartridge further comprises a thermal conductor in thermal contact with the multiplexed optical chip, optionally wherein the protective enclosure comprises at least one aperture for access to the thermal conductor. In some embodiments, the cartridge further comprises a flow cell in fluidic connection with the plurality of reaction regions on the multiplexed optical chip, optionally wherein the protective enclosure comprises at least one aperture for access to the flow cell. In any of these embodiments, the at least one aperture can be covered by a retractable protective shield.

In some of the above cartridge embodiments comprising a connector element, the cartridge further comprises a non-volatile, rewritable memory or a user-observable connection indicator in electronic contact with the connector element, optionally wherein the user-observable connection indicator comprises a light-emitting diode.

In some embodiments, the nucleic acid sequencing cartridge further comprises an electrostatic discharge protection element, optionally wherein the electrostatic discharge protection element comprises an electrostatic discharge dissipative plastic, a metallization, or a low-resistance foam. In some embodiments, the protective enclosure comprises an ejection pin on an external surface of the protective enclosure, wherein the ejection pin is configured for reversible association with an optical sequencing system. In some embodiments, the multiplexed optical chip is attached to a printed circuit board.

In some of the above cartridge embodiments comprising a flow cell, the flow cell comprises at least two fluidic ports, optionally wherein the flow cell comprises at least one input fluidic port and at least one output fluidic port, or at least four fluidic ports, optionally wherein the flow cell comprises at least two input fluidic ports and at least two output fluidic ports. In specific embodiments, the flow cell further comprises at least one trunk line, wherein the at least one trunk line is in fluidic connection with at least one input fluidic port, and wherein the at least one trunk line is configured to direct air bubbles away from the plurality of reaction regions.

In other specific embodiments, the at least two fluidic ports of the flow cell are independently controllable by fluidic valves, optionally wherein the flow cell further comprises at least one trunk line, wherein the at least one trunk line is in fluidic connection with at least one input fluidic port, and wherein the at least one trunk line is configured to direct air bubbles away from the plurality of reaction regions.

In some cartridge embodiments comprising a flow cell, the flow cell further comprises a physical alignment element, optionally wherein the physical alignment element comprises a hole, a slot, or a hole and a slot.

In some cartridge embodiments comprising a flow cell, the flow cell is fabricated from a material that is at least partly transparent to UV radiation, and optionally comprises a bottom surface in contact with the multiplexed chip, wherein the bottom surface is at least partially covered by a material that is at least partly opaque to visible light. In some embodiments, the flow cell is attached to the multiplexed optical chip by a UV-cure adhesive. In specific embodiments, the transparent material in the above flow cells can be a UV-transparent plastic, such as an acrylonitrile butadiene styrene plastic. In other specific embodiments, the material that is at least partly opaque to visible light is a paint, a laser engraved or embossed material, or an opaque plastic material.

In another aspect, the disclosure provides packaged nucleic acid sequencing devices comprising:

a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions;
   wherein the multiplexed optical chip is attached to a printed circuit board.

In embodiments, the printed circuit board of the packaged nucleic acid sequencing devices comprise a connector element in electronic contact with the optical detector. In specific embodiments, the connector element is an edge connector, optionally further comprising a non-volatile rewritable memory or a user-observable connection indicator in electronic contact with the connector element.

In some embodiments, packaged nucleic acid sequencing device further comprises an electrostatic discharge protection element, a thermal conductor in thermal contact with the multiplexed optical chip, a flow cell in fluidic contact with the plurality of reaction regions on the multiplexed optical chip, or a combination of these features. More specifically, the electrostatic discharge protection element, the thermal conductor in thermal contact with the multiplexed optical chip, and the flow cell in fluidic contact with the plurality of reaction regions on the multiplexed optical chip can be any of the corresponding features described in the above nucleic acid sequencing cartridges.

In yet another aspect are provided packaged nucleic acid sequencing devices comprising:

a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions; and

a flow cell in fluidic connection with the plurality of reaction regions on the multiplexed optical chip.

In specific embodiments, the flow cell in fluidic contact with the plurality of reaction regions on the multiplexed optical chip can be any of the corresponding features described in the above nucleic acid sequencing cartridges or packaged nucleic acid sequencing devices.

In still yet another aspect are provided systems for optical analysis comprising:

an optical source;

a nucleic acid sequencing cartridge comprising:
a multiplexed optical chip comprising;
   a plurality of reaction regions;
   at least one optical waveguide optically coupled to the plurality of reaction regions;
   an optical coupler optically coupled to the at least one optical waveguide; and
   an optical detector optically coupled to the plurality of reaction regions; and
a flow cell in fluidic connection with the plurality of reaction regions on the multiplexed optical chip;
   wherein the multiplexed optical chip is attached to a printed circuit board; and
   wherein the multiplexed optical chip and the printed circuit board are surrounded by a protective enclosure.

In some embodiments, the systems comprise the nucleic acid sequencing cartridges described above, the packaged nucleic acid sequencing devices described above, the flow cells described above, or a combination of these more specific components.

In some embodiments, the system further comprises a beam dump. In some embodiments, the system further comprises a fluidic clamp, optionally wherein the fluidic clamp comprises a plurality of clamping ports in fluidic connection with the flow cell, wherein the system further comprises a syringe pump in fluidic connection with the fluidic clamp, wherein the fluidic clamp is driven by a cam mechanism, or wherein the fluidic clamp comprises a beam dump.

In some system embodiments, the optical source is replaceable by a user.

In other system embodiments, the optical source is configured to emit an optical excitation beam, and the optical excitation beam is coupled to the optical coupler. More specifically, in some of these embodiments, the system is configured to move either the multiplexed optical chip or the optical excitation beam to maximize an optical alignment signal, the system does not include an alignment camera, or the multiplexed optical chip comprises at least one alignment feature at a defined location on the multiplexed optical chip.

In some embodiments, the system further comprises a cooling system in thermal contact with the multiplexed optical chip, optionally wherein the cooling system comprises an air blower or wherein the cooling system comprises a thermoelectric cooler.

In other system embodiments, the multiplexed optical chip comprises at least 2, at least 5, at least 10, at least 50, at least 100, at least 500, at least 1,000, at least 5,000, at least 10,000, or at least 50,000 optical waveguides, the multiplexed optical chip comprises no more than 100,000, no more than 50,000, no more than 10,000, no more than 5,000, no more than 1,000, no more than 500, or no more than 100 optical waveguides, or the multiplexed optical chip comprises from 1 to 100,000, from 100 to 10,000, or from 500 to 5,000 optical waveguides.

In some embodiments, the system further comprises a computer that receives at least one electronic signal from the optical detector and analyzes the at least one electronic signal, optionally wherein the analysis comprises obtaining nucleic acid sequencing information.

In some system embodiments, the optical source has a wavelength of excitation from about 450 nm to about 700 nm or from about 500 nm to about 650 nm, the multiplexed optical chip is fabricated on a silicon chip, the optical detector comprises a CMOS sensor, the plurality of reaction regions comprises a plurality of nucleic acid samples, the plurality of reaction regions comprises a plurality of nanoscale wells, or the plurality of reaction regions comprises a plurality of zero mode waveguides, in any combination.

### BRIEF DESCRIPTION OF THE FIGURES

FIG. 1 shows an analytical system comprising an optical source and a target optical waveguide device.

FIG. 2 shows a block diagram of an integrated analytical device.

FIG. 3 shows a more detailed view of an exemplary device architecture for performing fluorescence analyses.

FIG. 4A shows a frontside perspective of an exemplary cartridge-type nucleic acid sequencing device.

FIG. 4B shows an exemplary dual-connector cartridge.

FIG. 5 shows a backside perspective of an exemplary cartridge-type nucleic acid sequencing device.

FIG. 6 shows a frontside perspective of the nucleic acid sequencing cartridge of FIG. 4A with the top cover removed.

FIG. 7 shows a frontside perspective of the nucleic acid sequencing cartridge of FIG. 4A with the top cover and the flow cell removed.

FIGS. 8A and 8B show design features of two exemplary 4-port flow cells. FIG. 8C shows the top view of an exemplary 2-port flow cell. FIG. 8D shows a comparison of heat maps for chips loaded using either a 2-port flow cell process (top) or a traditional, open-well process (bottom). FIG. 8E shows an exemplary process for loading a chip using a 4-port flow cell.

FIG. 9 shows an exemplary fluidic clamping mechanism for interfacing the flow cell of a nucleic sequencing cartridge with an analytical instrument.

FIG. 10 shows an exemplary cooling system for use in a system for nucleic acid sequencing.

FIG. 11 shows an exemplary system for nucleic acid sequencing that includes an inserted cartridge-type nucleic acid sequencing device.

FIGS. 12A and 12B show two views of a multiplexed optical chip with an attached flow cell. FIGS. 12C-12F show novel designs to minimize passage of excitation optical energy through the structural components of the flow cell.

FIGS. 13A and 13B illustrate sample loading workflows utilizing flow, re-flow, and recirculation of samples on an optical chip device.

FIG. 14 illustrates an exemplary overall workflow for the delivery of a nucleic acid sample by a user onto an optical chip device.

FIG. 15 illustrates an exemplary low-volume sample delivery device.

FIG. 16 illustrates an alternative low-volume sample delivery device.

FIGS. 17A and 17B illustrate exemplary cartridge devices with an associated sample reservoir and fluidic valve.

FIGS. 18A-18D provides a comparison of fluid line volumes for alternative cartridge device embodiments.

### DETAILED DESCRIPTION OF THE INVENTION

### General

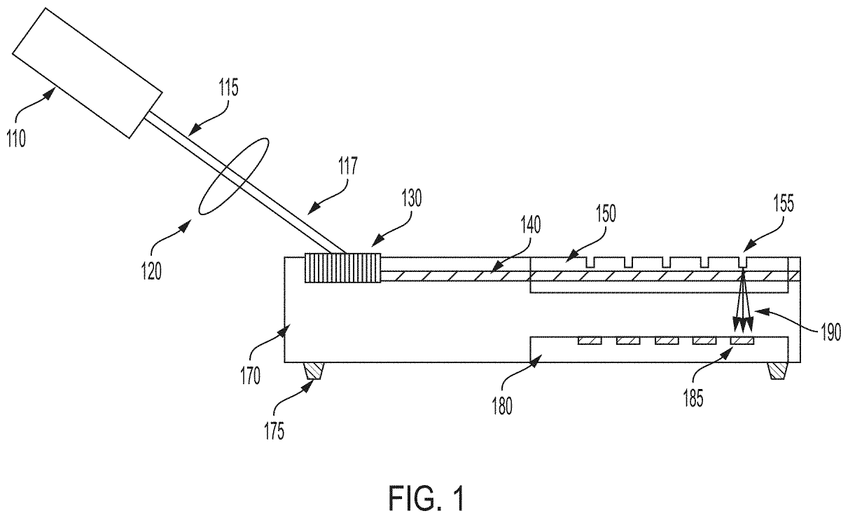

An exemplary optical analytical system comprising an optical source and an integrated target waveguide device is illustrated in FIG. 1. A laser or laser system 110, serving as the optical source, emits illumination light 115, also referred to as an optical excitation signal or optical excitation beam, into free space. The laser 110 as represented in this figure can in some cases emit light 115 directly into free space. In other cases, the laser 110 includes other optical elements through which the light travels prior to being emitted into free space. For example, the other optical elements included with the laser can include an optical fiber, a PLC, or a combination of both prior to emission of the illumination light 115 into free space. In some cases, the illumination light emitted from the laser is sent directly to a target, for example a target device 170, which may also be referred to herein as a “multiplexed optical chip”. Typically, the illumination light 115 will pass through one or more optical elements 120 which are used to shape, steer, or otherwise control the properties of the illumination light prior to reaching the target. The illumination light that has been shaped and steered 117 by the one or more optical elements 120 is coupled into an optical waveguide 140. The light is transmitted through the optical waveguide to an area of interest 150 on the target device. Typically, and as shown here, an optical coupler 130, such as a grating coupler, is used to launch the illumination light into the optical waveguide. While a grating coupler is shown, it is to be understood that any type of coupler, prism, or other interface optical element or method, including, for example, direct butt-coupling, can be used to direct an optical excitation signal from an optical source into the optical waveguide.

The area of interest 150, which in the case of a nucleic acid sequencing device may also be referred to as a “sequencing area” or “sequencing region”, has a plurality of reaction regions 155, for example nanowells or zero mode waveguides (ZMWs). The optical waveguide 140 typically extends underneath the reaction regions 155, thereby illuminating the reaction regions from below by optical coupling with evanescent wave illumination. The reaction regions preferably contain fluorescent reactants, which, when excited by the evanescent wave illumination, emit fluorescent light 190, which can be detected in order to carry out the desired analysis (e.g., nucleic acid sequencing). In some cases, and as shown here, the target device also has an integrated sensor 180, also referred to as an optical detector. The emitted fluorescent light from the reaction regions is optically coupled through the device to be detected at a single pixel or group of pixels 185 within the optical detector. Such integrated target devices for fluorescence analysis are described, for example in U.S. Patent Publication Nos. 2008/0128627, 2012/0085894, 2016/0334334, 2016/0363728, 2016/0273034, 2016/0061740, and 2017/0145498 which are each incorporated herein by reference in their entireties. Target devices that include integrated optical detectors will also typically include electronic outputs 175. For example, the integrated optical detector detects and processes an optical emission signal, and then sends electronic data related to the detected signals out of the device through an electronic output or outputs. The electronic outputs can, for example, be bond pads on a silicon chip, which are typically wire bonded to a chip package, and the chip package will have electronic outputs for passing on the electronic signals from the chip. The electronic signals are typically sent to a computer (not shown), which processes the received signals to perform the desired analysis.

The optical waveguide on the target device can be any suitable waveguide including a fiber, a planar waveguide, or a channel waveguide. Typically channel waveguides are used. The waveguide is preferably a single mode waveguide, but it can be a multi-mode waveguide for some applications.

In FIG. 1, the optical waveguide 140 is shown as being on a target device, which can be a semiconductor chip, for example, a silicon chip. Particular systems of interest with respect to the invention are SiON waveguides, for example those formed on silicon chips. The SiON waveguide will have a core of SiON, and is typically surrounded by a cladding material of lower refractive index such as silicon dioxide (SiO₂). As is known in the art, SiON can be formed in a deposition process, and the ratio of the elements can be adjusted to control the optical properties of the waveguide. For example, the ratio of oxygen to nitrogen can be varied in order to change the refractive index of the film. For the SiON waveguides of the devices and systems of the disclosure, the composition is often controlled to have a refractive index greater than about 1.6, greater than about 1.7, or greater than about 1.8. The refractive index can be measured, for example, at the sodium D line.

### Waveguide-Addressed Analytical Devices and Systems

The present disclosure is generally directed to improved devices and systems for performing analytical operations, and particularly optical analysis of chemical, biochemical, and biological reactions for use in chemical, biological, medical, and other research and diagnostic applications. These devices and systems are particularly well suited for application in integrated analytical components, e.g., where multiple functional components of the overall analysis system are co-integrated within a single modular component. However, as will be clear upon reading the following disclosure, a number of aspects of the invention will have broad utility outside of such integrated devices and systems.

In general, the optical analyses that are subjects of the present disclosure seek to gather and detect one or more optical emission signals from a reaction of interest, the appearance or disappearance of which, or localization of which, is indicative of a given chemical or biological reaction and/or the presence or absence of a given substance within a sample material. In some cases, the reactants, their products, or other substance of interest (all of which are referred to as reactants herein) inherently present an optically detectable signal. In other cases, reactants are provided with exogenous labeling groups to facilitate their detection.

### Nucleic Acid Sequencing

As is understood by those of ordinary skill in the art, fluorescently labeled nucleotides are used in a wide variety of different nucleic acid sequencing analyses. For example, in some cases such labels are used to monitor the polymerase-mediated, template-dependent incorporation of nucleotides in a primer extension reaction. In particular, a labeled nucleotide can be introduced to a primer template polymerase complex, and incorporation of the labeled nucleotide into the primer can be detected. If a particular type of nucleotide is incorporated at a given position, it is indicative of the underlying and complementary nucleotide in the sequence of the template molecule. In traditional Sanger sequencing processes, the detection of incorporated labeled nucleotides utilizes a termination reaction, where the labeled nucleotides carry a terminating group that blocks further extension of the primer. By mixing the labeled terminated nucleotides with unlabeled native nucleotides, nested sets of fragments are generated that terminate at different nucleotides. These fragments can then be separated by capillary electrophoresis, or other suitable technique, to distinguish those fragments that differ by a single nucleotide, and the labels for the fragments can be read in order of increasing fragment size to provide the sequence of the fragment (as indicated by the last added, labeled terminated nucleotide). By providing a different fluorescent label on each of the types of nucleotides that are added, the different nucleotides in the sequence can readily be differentiated (see, e.g., U.S. Pat. No. 5,821,058, which is incorporated herein by reference in its entirety for all purposes).

In some sequencing technologies, arrays of primer-template complexes are immobilized on surfaces of substrates such that individual molecules or individual and homogeneous groups of molecules (clonal populations) are spatially discrete from other individual molecules or groups of molecules, respectively. Labeled nucleotides are added in a manner that results in a single nucleotide being added to each individual molecule or group of molecules. Following the addition of the nucleotide, the labeled addition is detected and identified.

In some cases, the sequencing analyses utilize the addition of a single type of nucleotide at a time, followed by a washing step. The labeled nucleotides that are added are then detected, their labels removed, and the process repeated with a different nucleotide type. Sequences of individual template sequences are determined by the order of appearance of the labels at given locations on the substrate.

In other similar cases, the immobilized complexes are contacted with all four types of labeled nucleotides, where each type of nucleotide bears a distinguishable fluorescent label and a terminator group that prevents the addition of more than one nucleotide in a given step. Following the single incorporation in each individual template sequence (or group of template sequences), the unbound nucleotides are washed away, and the immobilized complexes are scanned to identify which nucleotide was added at each location. Repeating the process yields sequence information of each of the template sequences. In other cases, more than four types of labeled nucleotides are utilized.

In particularly elegant approaches, labeled nucleotides are detected during the incorporation process itself, in real time, by individual molecular complexes. Such methods are described, for example, in U.S. Pat. No. 7,056,661, which is incorporated herein by reference in its entirety for all purposes. In these processes, nucleotides are labeled on a terminal phosphate group that is released during the incorporation process, so as to avoid the accumulation of labels on the extension product, and accordingly to avoid any need for label removal processes that can potentially be deleterious to the complexes. Primer/template polymerase complexes are observed during the polymerization process, and nucleotides being added are detected by virtue of their associated labels.

In one particular example, labeled nucleotides can be observed using an optically confined structure, such as a zero mode waveguide (see, e.g., U.S. Pat. No. 6,917,726, which is incorporated herein by reference in its entirety for all purposes) that limits exposure of the excitation radiation to the volume immediately surrounding an individual primer/template polymerase complex. As a result, only labeled nucleotides that are retained by the polymerase during the process of being incorporated are exposed to excitation illumination for a time that is sufficient to generate fluorescence and thus to identify the incorporated nucleotide. Exemplary chips having arrays of nanoscale wells or zero mode waveguides and that are therefore considered suitable for these purposes include substrates having a metal or metal oxide layer on a silica-based layer, with nanoscale wells disposed through the metal or metal oxide layer to or into the silica-based layer (see, e.g., U.S. Pat. Nos. 6,917,726, 7,302,146, 7,907,800, 8,802,600, 8,906,670, 8,993,307, 8,994,946, 9,223,084, 9,372,308, and 9,624,540, which are each incorporated herein by reference in their entireties).

In another approach, the label on the nucleotide is configured to interact with a complementary group on or near the complex, e.g., attached to the polymerase, where the interaction provides a unique signal. For example, a polymerase may be provided with a donor fluorophore that is excited at a first wavelength and emits at a second wavelength, while the nucleotide to be added is labeled with a fluorophore that is excited at the second wavelength, but emits at a third wavelength (see, e.g., U.S. Pat. No. 7,056,661, previously incorporated herein). As a result, when the nucleotide and polymerase are sufficiently proximal to each other to permit energy transfer from the donor fluorophore to the label on the nucleotide, a distinctive signal is produced. Again, in these cases, the various types of nucleotides are provided with distinctive fluorescent labels that permit their identification by the spectroscopic or other optical signature of their labels.

In the various exemplary processes described above, detection of a signal event from a reaction region is indicative that a reaction has occurred. Further, with respect to many of the above processes, identification of the nature of the reaction, e.g., which nucleotide was added in a primer extension reaction at a given time or that is complementary to a given position in a template molecule, is also achieved by distinguishing the spectroscopic characteristics of the signal event.

The optical paths of the analytical systems of the disclosure serve one or more roles of delivering excitation radiation to the reaction region, e.g., to excite fluorescently-labeled molecules that then emit the relevant optical emission signal, conveying the optical signal emitted from the reaction region to the optical detector, and, for multispectral signals, i.e., multiple signals that may be distinguished by their emission spectrum, separating those signals so that they may be differentially detected, e.g., by directing different signals to different optical detectors or different regions on the same optical detector array. The differentially detected signals are then correlated with both the occurrence of the reaction, e.g., a nucleotide was added at a given position, and the determination of the nature of the reaction, e.g., the added nucleotide is identified as a particular nucleotide type, such as adenosine.

In conventional, fully free-space, analytical systems used for nucleic acid sequencing, the optical trains used to deliver excitation light to the reaction regions, and to convey optical signals from the reaction regions to the detector(s) can impart size, complexity, and cost aspects to the overall system that would preferably be reduced. For example, such optical trains may include collections of lenses, dispersion elements, beam splitters, beam expanders, collimators, spatial and spectral filters and dichroics, that are all assembled to deliver targeted and uniform illumination profiles to the different reactions regions. In large-scale systems, these components must be fabricated, assembled, and adjusted to ensure proper alignment, focus, and isolation from other light and vibration sources to optimize the transmission of excitation light to the reaction regions. As the number of addressed reaction regions, or the sensitivity of the system to variations in excitation light intensity is increased, addressing these and other issues becomes more important, and again typically involves the inclusion of additional componentry to the optical train, e.g., alignment and focusing mechanisms, isolation structures, and the like.

With respect to the collection and detection of optical emission signals, conventional systems typically employ optical trains that gather emitted optical signals from the reaction region, e.g., through an objective lens system, transmit the various different signals through one or more filter levels, typically configured from one or more dichroic mirrors that differentially transmit and reflect light of different wavelengths, in order to direct spectrally different optical signals to different detectors or regions on a given detector. These separated optical signals are then detected and used to identify the nature of the reaction that gave rise to such signals. As will be appreciated, the use of such differential direction optics imparts substantial space, size, and cost requirements on the overall system, in the form of multiple detectors, multiple lens and filter systems, and in many cases complex alignment and correlation issues. Many of these difficulties are further accentuated where the optical trains share one or more sub-paths with the excitation illumination, as signal processing will include the further requirement of separating out background excitation illumination from each of the detected signals.

Again, as with the excitation optical train, above, as the sensitivity and multiplex of the system is increased, it increases the issues that must be addressed in these systems, adding to the complexity of an already complex optical system. Further, the greater the number of optical components in the optical train, the greater the risk of introducing unwanted perturbations into that train and the resulting ability to detect signal. For example, optical aberrations in optical elements yield additional difficulties in signal detection, as do optical elements that may inject some level of autofluorescence into the optical train, which then must be distinguished from the signaling events.

In some embodiments, the systems of the instant disclosure further comprise a computer that receives at least one electronic signal from an optical detector, or region of an optical detector, for example the detected signals described above, and analyzes the at least one electronic signal. More specifically, the analysis performed by the computer can comprise obtaining nucleic acid sequencing information from the electronic signal, as would be understood by those of ordinary skill in the art.

### Integrated Devices

The nucleic acid sequencing cartridges, packaged devices, and analytical systems of the instant disclosure typically comprise one or more small-scale integrated analytical devices that optionally also include one or more reaction regions, fluidic components, and excitation illumination paths and optionally excitation illumination sources. Integration of some or all of the above-described components into a single, miniaturized analytical device, also referred to as a multiplexed optical chip, addresses many of the problems facing larger, non-integrated analytical systems, such as size, cost, weight, inefficiencies associated with long path or free space optics, and the like. For example, highly multiplexed analytical systems comprising integrated waveguides for the illumination of nanoscale samples are described in U.S. Patent Publication Nos. 2008/0128627, 2012/0085894, 2016/0334334, 2016/0363728, 2016/0273034, 2016/0061740, and 2017/0145498, which are each incorporated herein by reference in their entireties. Additional nanoscale illumination systems for highly multiplexed analysis are described in U.S. Patent Publication Nos. 2014/0199016 and 2014/0287964, which are each incorporated herein by reference in their entireties.

Other examples of such integrated analytical systems are described, for example, in U.S. Patent Application Publication Nos. 2012/0014837, 2012/0019828, and 2012/0021525, which are each incorporated herein by reference in their entireties. By integrating the detection elements with the reaction regions, either directly or as a coupled part, the need for many of the various components required for free space optics systems, such as much of the conveying optics, lenses, mirrors, and the like, can be eliminated. Other optical components, such as various alignment functionalities, can also in many cases be eliminated, as alignment is achieved through the direct integration of the detection elements with the reaction regions. The cartridges, packaged devices, and systems of the present disclosure further improve the benefits afforded by such multiplexed devices by simplifying, to a greater extent, the optical, electronic, fluidic, mechanical, and thermal components of the analytical devices, thus further reducing the cost and complexity of such devices, and further improving the available signal in the process.

In an exemplary embodiment, the multiplexed optical chips of the instant cartridges, packaged devices, and systems include an array of analytical devices formed as a single integrated device that is typically configured for single use as a consumable device. In various embodiments, the integrated device includes other components including, but not limited to local fluidics, electronic connections, a power source, illumination elements, a detector, logic, and a processing circuit. Each analytical device in the array is preferably configured for performing an analytical operation, as described above.

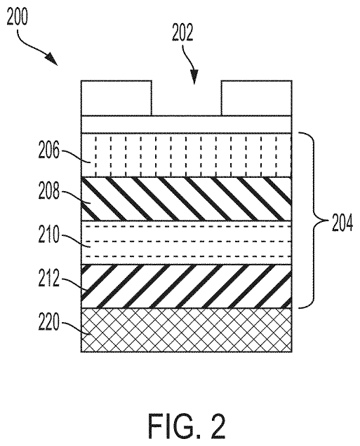

While the components of each integrated device and the configuration of the devices in the system can vary, each analytical device within the system can comprise, at least in part, the general structure shown as a block diagram in FIG. 2. As shown, an analytical device 200 typically includes a reaction cell 202, in which the reactants are disposed and from which the optical emission signals emanate. “Reaction cell” is to be understood as generally used in the analytical and chemical arts and refers to the location where the reaction of interest is occurring. Thus, “reaction cell” can include a fully self-contained reaction well, vessel, flow cell, chamber, or the like, e.g., enclosed by one or more structural barriers, walls, lids, and the like, or it can comprise a particular region on a substrate and/or within a given reaction well, vessel, flow cell or the like, e.g., without structural confinement or containment between adjacent reaction cells. The reaction cell can include structural elements to enhance the reaction or its analysis, such as optical confinement structures, nanowells, posts, surface treatments, such as hydrophobic or hydrophilic regions, binding regions, or the like.

In various respects, “analytical device” or “integrated analytical device” refers to a reaction cell and associated components that are functionally connected. In various respects, “analytical system” refers to the larger system including the analytical device and other instruments for performing an analysis operation. For example, in some cases, the nucleic acid sequencing cartridges and packaged devices of the disclosure are part of an analytical instrument or analytical system. The nucleic acid sequencing cartridge or packaged device can be removably coupled into the instrument. Liquid samples and/or reagents can be brought into contact with the sequencing cartridge or packaged device before or after the sequencing cartridge or packaged device is coupled with the system. The system can provide electronic signals and/or illumination light to the sequencing cartridge or packaged device, and can receive electronic signals from the detectors or other electronic components in the sequencing cartridge or packaged device. The system can also provide mechanical support for and/or thermal exchange with the sequencing cartridge or packaged device. The instrument or system can have computers to manipulate, store, and analyze the data from the sequencing cartridge or packaged device. For example, the instrument can have the capability of identifying the order of added nucleotide analogs in a nucleic acid sequencing reaction. The identification can be carried out, for example, as described in U.S. Pat. No. 8,182,993, which is incorporated herein by reference for all purposes.

In some cases, one or more reactants involved in the reaction of interest can be immobilized, entrained or otherwise localized within a given reaction cell. A wide variety of techniques are available for localization and/or immobilization of reactants, including surface immobilization through covalent or non-covalent attachment, bead or particle based immobilization, followed by localization of the bead or particle, entrainment in a matrix at a given location, and the like. Reaction cells can include ensembles of molecules, such as solutions, or patches of molecules, or they can include individual molecular reaction complexes, e.g., one molecule of each molecule involved in the reaction of interest as a complex. Similarly, the sequencing cartridges and packaged devices of the disclosure can include individual reaction cells or can comprise collections, arrays, or other groupings of reaction cells in an integrated structure, e.g., a multiwall or multi-cell plate, chip, substrate, or system. Some examples of such arrayed reaction cells include nucleic acid array chips, e.g., GeneChip® arrays (Affymetrix, Inc.), zero mode waveguide arrays (as described elsewhere herein), microwell and nanowell plates, multichannel microfluidic devices, e.g., LabChip® devices (Caliper Life Sciences, Inc.), and any of a variety of other reaction cells. In various respects, the “reaction cell”, sequencing layer, and zero mode waveguides are similar to those described in U.S. Pat. No. 7,486,865, the entire contents of which is incorporated herein by reference for all purposes. In some cases, these arrayed devices can share optical components within a single integrated overall device, e.g., a single waveguide layer to deliver excitation light to each reaction region. Approaches to illuminating analytical devices with waveguides are provided in U.S. Pat. Nos. 8,207,509 and 8,274,040, which are each incorporated herein by reference for all purposes.

Although an analytical system may include an array of analytical devices having a single waveguide layer and reaction cell layer, it can be appreciated that a wide variety of layer compositions can be employed in the waveguide array substrate and cladding/reaction cell layer while still achieving the goals of the device (see, e.g., U.S. Pat. No. 7,820,983, incorporated herein by reference for all purposes).

The multiplexed optical chips of the instant cartridges, packaged devices, and systems typically include a plurality of analytical devices 200 as illustrated in FIG. 2 having a detector element 220, which is disposed in optical communication with the reaction cell 202. Optical communication between the reaction cell 202 and the detector element 220 can be provided by an optical train 204 comprised of one or more optical elements generally designated 206, 208, 210 and 212 for efficiently directing the signal from the reaction cell 202 to the detector 220. These optical elements can generally comprise any number of elements, such as lenses, filters, gratings, mirrors, prisms, refractive material, or the like, or various combinations of these, depending upon the specifics of the application. In addition to components for directing the optical emission signal from the reaction region to the detector, the chip can also have optical components for delivering illumination light to the reaction regions for performing fluorescent measurements.

In various embodiments, the reaction cell 202 and detector element 220 are provided along with one or more optical elements in an integrated device structure. By integrating these elements into a single device architecture, the efficiency of the optical coupling between the reaction cell and the detector can be improved. As used herein, the term integrated, when referring to different components of an analytical device typically refers to two or more components that are coupled to each other so as to be immobile relative to each other. As such, integrated components can be irreversibly or permanently integrated, meaning that separation would damage or destroy one or both elements, or they can be removably integrated, where one component can be detached from the other component, provided that when they are integrated, they are maintained substantially immobile relative to one another. In some cases, the components are integrated together, for example as a single fabricated device, such as in a single silicon chip. In some cases, the detector portion is part of a separate instrument, and the reaction cell component is part of a detachable device, such as a detachable chip. In the case where the reaction cell component is in a chip separate from the detector component, optical element components for directing the optical emission signal from the reaction cell to the detector can be in either the reaction cell component, in the detector component, or a combination in which some components are in the reaction cell component and others are in the detector component.

In conventional optical analysis systems, discrete reaction vessels are typically placed into optical instruments that utilize only free-space optics to convey the optical signals to and from the reaction vessel and to the detector. These free space optics tend to include higher mass and volume components, and have free space interfaces that contribute to a number of weaknesses for such systems. For example, such systems have a propensity for greater losses of light given the introduction of unwanted leakage paths from these higher mass components. They also typically introduce higher levels of auto-fluorescence. All of these inherent weaknesses reduce the signal-to-noise ratio (SNR) of the system and reduce its overall sensitivity, which, in turn can impact the speed, accuracy, and throughput of the system. Additionally, in multiplexed applications, signals from multiple reaction regions (i.e., multiple reaction cells, or multiple reaction locations within individual cells), are typically passed through a common optical train, or common portions of an optical train, using the full volume of the optical elements in that train to be imaged onto the detector plane. As a result, the presence of optical aberrations in these optical components, such as diffraction, scattering, astigmatism, and coma, degrade the signal in both amplitude and across the field of view, resulting in greater noise contributions and cross talk among detected signals.

In some cases, the reaction region of the instant multiplexed optical chips comprises a nanoscale well, for example, a nanoscale well having no linear dimension of greater than 500 nm A nanoscale well of the optical chips of the disclosure can, for example, be cylindrical with a base diameter between about 50 nm and 200 nm. The depth of the well can, for example, be from about 50 nm to about 400 nm In some cases, the reaction regions can comprise zero mode waveguides (ZMWs). Zero mode waveguides are described, for example in U.S. Pat. Nos. 7,170,050, 7,486,865, and 8,501,406 which are each incorporated herein by reference in their entireties.

Such devices have sought to take advantage of the proximity of the reaction region or vessel in which signal producing reactions are occurring, to the detector or detector element(s) that sense those signals, in order to take advantage of benefits presented by that proximity. As alluded to above, such benefits include the reduction of size, weight, and complexity of the optical train, and as a result, increase the potential multiplex of a system, e.g., the number of different reaction regions that can be integrated and detected in a single cartridge, packaged device, or system. Additionally, such proximity potentially provides benefits of reduced losses during signal transmission, reduced signal cross-talk from neighboring reaction regions, and reduced costs of overall systems that utilize such integrated devices, as compared to systems that utilize large free space optics and multiple cameras in signal collection and detection.

In the multiplexed optical chips of the present disclosure, there are a number of design criteria that can benefit from optimization. For example, in these optical chips, an over-arching goal is in the minimization of intervening optical elements that could interfere with the efficient conveyance of optical emission signals from the reaction region to the detector, as well as contribute to increased costs and space requirements for the device, by increasing the complexity of the optical elements between the reaction regions and the sensors.

Additionally, and with added importance for single molecule detection systems, it is also important to maximize the amount of optical emission signal that is detected for any given reaction event. In particular, in optical detection of individual molecular events, a relatively small number of photons corresponding to the event of interest are typically relied on in the measurements. While high quantum yield labeling groups, such as fluorescent dyes, can improve detectability, such systems still operate at the lower end of detectability of optical systems. Fluorescent dyes finding utility in the analytical reactions performed using the instant systems are well known. Any suitable fluorescent dye can be used, for example, as described in PCT International Publication No. WO2013/173844A1 and U.S. Patent Application Publication Nos. 2009/0208957A1, 2010/0255488A1, 2012/0052506A1, 2012/0058469A1, 2012/0058473A1, 2012/0058482A1, and 2012/0077189A1.

In the context of the cartridges, packaged devices, and systems of the present disclosure, the size and complexity of the optical pathways poses a greater difficulty, as there is less available space in which to accomplish the goals of separation of excitation and signal, or separation of one signal from the next. Accordingly, the multiplexed optical chips of the instant cartridges, packaged devices, and systems take advantage of simplified optical paths associated with the analyses being carried out, in order to optimize those analyses for the integrated nature of those optical chips.

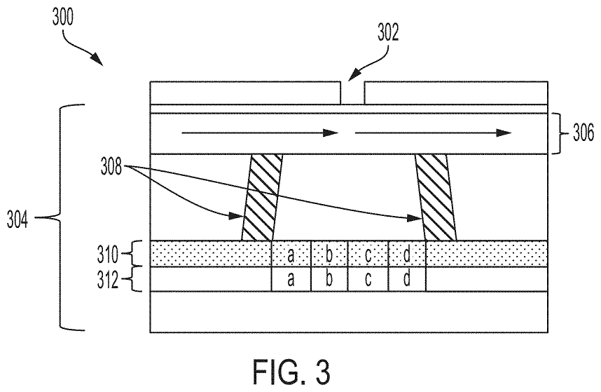

FIG. 3 illustrates in more detail an example of a device architecture for performing optical analyses, e.g., nucleic acid sequencing processes or single molecule binding assay. As shown, an integrated device 300 includes a reaction region 302 that is defined upon a first substrate layer 304. As shown, the reaction region 302 comprises a well disposed in the substrate surface. Such wells may constitute depressions in a substrate surface or apertures disposed through additional substrate layers to an underlying transparent substrate, e.g., as used in zero mode waveguide arrays (see, e.g., U.S. Pat. Nos. 7,181,122 and 7,907,800). FIG. 3 illustrates a portion of a device having one reaction region 302. Typically, a device will have multiple reaction regions, for example a device can comprise arrays with thousands, to millions, to tens of millions, or even more individual reaction regions.

Excitation illumination is delivered to the reaction region from an excitation light source (not shown) that may be separate from or may be integrated into the optical device. As shown, an optical waveguide (or waveguide layer) 306 is used to convey excitation light (shown by arrows) to the vicinity of reaction region 302, where an evanescent field emanating from the waveguide 306 illuminates reactants within the reaction region 302. Use of optical waveguides to illuminate reaction regions is described in e.g., U.S. Pat. Nos. 7,820,983, 8,207,509, and 8,274,040, which are each incorporated herein by reference for all purposes.

The integrated device 300 optionally includes light channeling components 308 to efficiently direct emitted light from the reaction regions to a detector layer 312 disposed beneath the reaction region. The detector layer will typically comprise multiple detector elements, for example the four illustrated detector elements 312a-d that are optically coupled to a given reaction region 302. For DNA sequencing applications, it is often desirable to monitor four different signals in real time, each signal corresponding to one of the nucleobases. The different signals can be distinguishable, for example, by wavelength, intensity, or any other suitable distinction, or combination of distinctions. Although illustrated as a linear arrangement of pixels 312a-d, it will be appreciated that the detector elements can be arranged in a grid, n by n square, annular array, or any other convenient orientation or arrangement. In some cases, each of the detector elements or channels will have a single pixel per reaction region, wherein the different analytical signals may be distinguishable by, for example, their different intensities. In some cases, the detector elements will each comprise multiple pixels, for example two, three, four, or even more pixels per reaction region. The detector elements are connected electronically to conductors that extend out of the chip for providing electronic signals to the detector elements and for sending out signals from the detector elements, for example to an attached processor. In some embodiments, the detector layer is a CMOS wafer or the like, i.e., a wafer made up of CMOS sensors or CCD arrays. See, for example, CMOS Imagers From Phototransduction to Image Processing (2004) Yadid-Pecht and Etienne-Cummings, eds.; Springer; CMOS/CCD Sensors and Camera Systems (2007) Holst and Lomheim; SPIE Press.

Emitted signals from the reaction region 302 that impinge on these detector elements are then detected and recorded. As illustrated in the integrated device of FIG. 3, the device may additionally include a color filter above each of the detector element, as disposed, for example, in filter layer 310. As shown in the drawing, “filter a” corresponds to the color filter associated with “channel a”, “filter b” corresponds to the color filter associated with “channel b”, and so forth. The set of filters is chosen to allow for a high yield of captured photons, for example with each color filter having one or more blocking bands that block the signal from a portion of one or more of the spectrally distinct signals emitted from the reaction occurring in reaction region 302. Specifically, the filters are designed to allow passage of a large percentage of the emitted photons, while still discriminating between the four bases. Where emitted signals are distinguished by their intensity, a single detector element may be able to identify multiple signals, for example signals emitted by multiple different nucleobases, by differences in optical intensity emitted from the reaction region by the sample at one wavelength or range of wavelengths.

In some cases, optical elements are provided to selectively direct light from given sets of wavelengths to given detector elements. Typically, no specific light re-direction is used, such that the light reaching each region of the filter layer is substantially the same.

The detector layer is operably coupled to an appropriate circuitry, typically integrated into the substrate, for providing a signal response to a processor that is optionally integrated within the same device structure or is separate from but electronically coupled to the detector layer and associated circuitry. Examples of the types of circuitry useful in such devices are described in U.S. Patent Application Publication No. 2012/0019828, previously incorporated by reference herein.

The multiplexed optical chips of the instant disclosure, which may also be referred to herein as target waveguide devices, target devices, or integrated analytical devices, typically have at least one optical coupler and an integrated waveguide that is optically coupled to the optical coupler and that delivers an input optical signal to the plurality of reaction regions. In some embodiments, the optical coupler of the instant devices is a low numerical aperture coupler. In some embodiments, the optical coupler is a diffraction grating coupler. In specific embodiments, the optical coupler is a diffraction grating coupler with low numerical aperture. In some cases, an optical source is directed onto a single coupler, while in other cases, the optical source is directed onto multiple couplers, for example from 2 to 16 couplers. In some cases, each coupler receives substantially the same power. In some cases, different power levels are directed to different couplers on the target device. While this description may refer to “the coupler” on the device, it is understood that in some cases there can be a single coupler, and that in other cases, there will be a plurality of couplers on a given device. Target waveguide devices having suitable couplers are described, for example, in U.S. Patent Application Publication No. 2016/0363728, which is incorporated herein by reference in its entirety.

Grating couplers and their use in coupling light, typically light from optical fibers, to waveguide devices are known in the art. For example, U.S. Pat. No. 3,674,335 discloses reflection and transmission grating couplers suitable for routing light into a thin film waveguide. In addition, U.S. Pat. No. 7,245,803 discloses improved grating couplers comprising a plurality of elongate scattering elements. The couplers preferably have a flared structure with a narrow end and a wide end. The structures are said to provide enhanced efficiency in coupling optical signals in and out of planar waveguide structures. U.S. Pat. No. 7,194,166 discloses waveguide grating couplers suitable for coupling wavelength division multiplexed light to and from single mode and multimode optical fibers. The disclosed devices include a group of waveguide grating couplers disposed on a surface that are all illuminated by a spot of light from the fiber. At least one grating coupler within the group of couplers is tuned to each channel in the light beam, and the group of couplers thus demultiplexes the channels propagating in the fiber. Additional examples of grating couplers are disclosed in U.S. Pat. No. 7,792,402 and PCT International Publication Nos. WO 2011/126718 and WO 2013/037900. A combination of prism coupling and grating coupling into an integrated waveguide device is disclosed in U.S. Pat. No. 7,058,261. In the multiplexed optical chips of the instant cartridges, packaged devices, and systems, optical energy can be provided from fibers, lenses, prisms, mirrors, or any other suitable optical source.

In the multiplexed optical chips of the instant cartridges and packaged devices, there can be a significant distance between the coupler and the area of interest, e.g., the reaction regions, as described above. The distance that the light travels in the waveguide from coupler to an area of interest can be, for example, several centimeters, for example from 1 cm to 10 cm. The distance referred to herein is the distance the light travels within the waveguide, e.g. the routing distance of the light through the waveguide or waveguides. Typically, where light is routed from a coupler over relatively long distances to an area of interest, a single waveguide is used to route the light from the coupler to a region close to the area of interest, where splitting of the routing waveguide into multiple waveguides can occur. Where multiple waveguide branches are desired within the area of interest, the splitting from a routing waveguide to waveguide branches in the area of interest is typically carried out near the area of interest rather than near the coupler, although in some embodiments, it can be advantageous for the splitting to occur nearer to the coupler, in particular where link efficiency variation is a problem, for example as described in U.S. Patent Application Publication No. 2016/0216538. One routing waveguide per coupler is typically the most efficient approach for routing over relatively long distances. Using one routing waveguide involves fewer elements and typically uses less space on the device than when multiple routing waveguides per coupler are used.

As just mentioned, the multiplexed optical chips of the instant cartridges, packaged devices, and systems advantageously comprise a plurality of optical waveguides, the optical waveguides configured to receive the optical excitation beam from the at least one optical coupler. For example, a multiplexed optical chip can comprise at least 2, at least 5, at least 10, at least 50, at least 100, at least 500, at least 1,000, at least 5,000, at least 10,000, or at least 50,000 optical waveguides. In some embodiments, the chip can comprise no more than 100,000, no more than 50,000, no more than 10,000, no more than 5,000, no more than 1,000, no more than 500, or no more than 100 optical waveguides. In other embodiments, the chip can comprise from 1 to 100,000, from 100 to 10,000, or from 500 to 5,000 optical waveguides.

In some embodiments, the multiplexed optical chip of the disclosed cartridges, packaged devices, and systems comprises at least one optical splitter, wherein the at least one optical splitter comprises an optical input and a plurality of optical outputs, and wherein the optical input of the at least one optical splitter is configured to receive the optical excitation beam from the optical coupler. Such devices also typically comprise a plurality of optical waveguides, the optical waveguides configured to receive the optical excitation beam from the plurality of optical outputs of the at least one optical splitter.

In specific embodiments, the multiplexed optical chip of the instant cartridges, packaged devices, and systems comprises no more than one optical coupler for providing illumination light to reaction regions. In other specific embodiments, the at least one optical splitter comprises 2 to 512 optical outputs.

In addition to the number of waveguides, the number of analytical regions per waveguide can be varied in order to obtain the desired level of multiplexing and performance. For example, the number of analytical regions per waveguide, e.g. nanoscale wells, can be, for example, from 1 to 100,000 analytical regions, from 100 to 10,000 analytical regions, or from 500 to 5,000 analytical regions on each waveguide of the chip. Those of skill in the art will understand how to set these numbers in order to obtain the desired performance and level of multiplex.

### Nucleic Acid Sequencing Cartridges and Packaged Nucleic Acid Sequencing Devices

Integrated chip devices for use in nucleic acid sequencing, for example the integrated optical chips described in the previous section, are traditionally bonded to ceramic substrates. Although such packaging provides a rigid and highly stable platform for the integrated device, it can be expensive to produce and inflexible, particularly where the optical chip is part of a consumer product, such as a table-top nucleic acid sequencing system. In such systems, the integrated chip is ideally designed to be readily and reliably removable and replaceable by an end user. For example, the sockets typically used in the computer chip industry for connection of integrated circuits to computer boards are not generally designed to allow rapid and convenient exchange of chips on a circuit board. Integrated chip devices are also typically quite small, which makes them relatively difficult to handle by an end user. The use of such chips in larger analytical systems, such as systems for nucleic acid sequencing, thus typically requires that the system includes a robotic handling system, or the like, which greatly increases cost and complexity of the systems.

The instant disclosure addresses these issues by providing, in some aspects, packaged nucleic acid sequencing devices comprising a multiplexed optical chip, for example any of the integrated waveguide devices described above, wherein the multiplexed optical chip is attached to a printed circuit board (PCB).

Suitable PCBs for use in the instant packaged nucleic acid sequencing devices are well known in the art. PCBs typically provide mechanical support for an attached chip device or devices. They also typically provide one or more electronic connections for the attached devices using, for example, conductive tracks, pads and/or other features etched from one or more sheet layers of copper laminated onto and/or between sheet layers of a non-conductive substrate. The individual chip devices, and any other components used in the packaged device, are generally soldered or wire bonded to the PCB to provide both an electronic connection and a solid mechanical site of attachment. In some embodiments, however, the optical chip is attached to the PCB using a silver-doped epoxy or other suitable method, for example, any “die attach” process for mechanical attachment of the chip to the PCB, as would be understood by those of ordinary skill in the art.

In the packaged nucleic acid sequencing devices of the instant disclosure, the multiplexed optical chip, including an associated optical detector, is preferably attached to a standard printed circuit board assembly that preferably also comprises an electronically-connected card-edge connector to facilitate the reversible connection of the packaged nucleic acid sequencing device with an analytical system. Analytical systems suitable for use with the packaged nucleic acid sequencing devices, which preferably also comprise an optical source and electronic controls, will be further described below. The printed circuit board assembly additionally optionally contains a non-volatile rewritable memory, for example an electrically erasable programmable read-only memory (EEPROM), or other comparable component, to store unique identifiers associated with the various components of the packaged device, including, for example, serial numbers, usage information, laser-to-chip alignment data, and the like. The printed circuit board assembly can likewise also optionally contain an LED, or other optical, audio, or tactile signal, to give an end user rapid feedback that an electronic connection between the cartridge and the analytical system has been formed.

The instant packaged devices also preferably comprise a rigid protective cartridge that encloses the multiplexed optical chip and the attached printed circuit board. Cartridge enclosures for electronic microcircuits and other types of electronic devices have been disclosed previously, in particular, in the video game industry (see, e.g., U.S. Pat. Nos. 4,095,791, 4,149,027, and 4,763,300, which are each incorporated herein by reference in their entireties). Such cartridge enclosures can advantageously protect the enclosed electronic and other sensitive components from electric discharge, in particular, where the cartridge will be handled by an end user. More details regarding suitable features to protect against electrostatic discharge are described below. Cartridge-type enclosures also provide an ergonomic gripping surface, also referred to as a finger grip, where the user can handle the cartridge without causing damage to mechanically or electronically fragile internal components. The enclosures can further provide an electronic connector, for example a card-edge connector, where the electronic components of the device, in particular the outputs from the CMOS sensor, can be reliably and reversibly connected to the electronic components of an analytical system. Cartridge-type enclosures can also provide retractable covers over apertures in the cartridge enclosure to reversibly expose electronic, optical, fluidic, and thermal connectors, while also protecting those connectors from physical damage or exposure prior to insertion of the cartridge into an analytical system. In some embodiments, the cartridges can include an inexpensive foil covering over one or more of the connection ports that can be removed by the end user prior to use. The foil can protect the optics and fluidics ports from dust and other types of contamination.

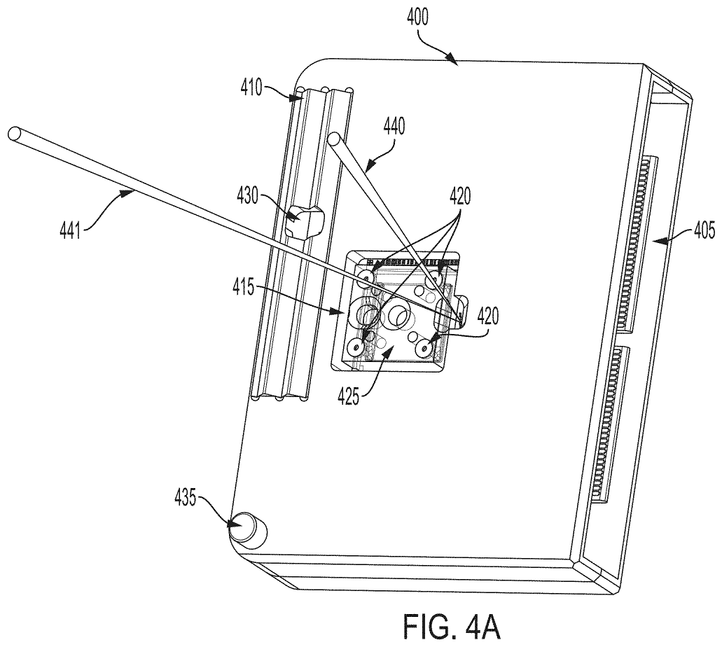

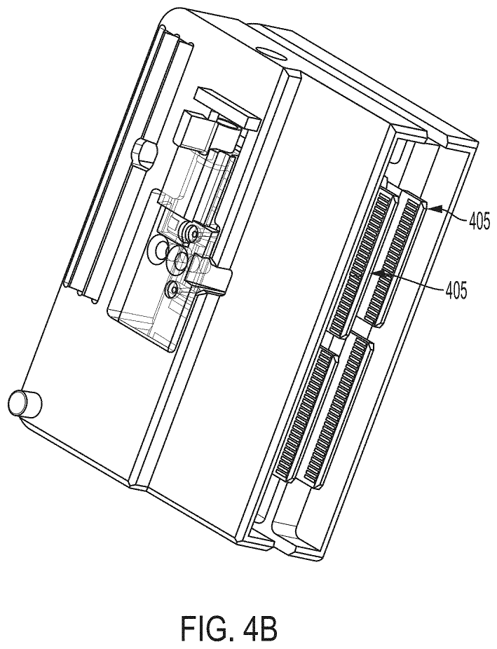

The instant inventors have designed cartridge enclosures for the above-described multiplexed optical nucleic acid sequencing chips that provide all of the above advantages. Various views of an exemplary nucleic acid sequencing cartridge comprising such a protective enclosure are shown in FIGS. 4A, 4B, 5, 6, and 7. Specifically, FIG. 4A shows a frontside perspective of such a cartridge 400, where various features of the exemplary device are illustrated, including a card-edge connector 405, a finger grip 410, an alignment feature for instrument fluidics 415, fluidic ports 420, a flow cell 425, a status light 430, and an ejection feature 435. Also shown is an input optical beam 440, that is provided by an optical source in an associated analytical system, and a reflected optical beam 441, that represents optical energy not coupled into the optical chip.

FIG. 4B shows an alternative exemplary cartridge embodiment comprising dual printed circuit boards. Advantageously, such a cartridge can significantly increase the multiplex of analytical reactions that can be achieved in these systems by enabling the use of multiple optical chips packaged within a single cartridge device. For example, the cartridge illustrated in FIG. 4B comprises two PCBs, where the card-edge connectors 405 of the two PCBs are exposed on the same edge of the cartridge. If each PCB carries one optical chip, the multiplex of such a cartridge can be double that of a cartridge containing a single PCB. While multiple optical chips could potentially be bonded to a single PCB substrate, such approaches can be problematic if the yield of each bonding step is relatively low. The bonding of a single optical chip to a single PCB substrate thus avoids the compounding of low yields for the assembly of multiple chips on a single PCB substrate while at the same time enabling enables increased multiplexing within a given sequencing instrument. For example, if each optical sequencing chip includes 30 million reaction regions, a cartridge comprising two PCBs, each PCB carrying one optical chip, can therefore provide 60 million reaction regions in a single device. In addition, multiple PCBs can optionally share a common cooling element that is in thermal contact with each of the optical chips on the PCBs. For example, in the exemplary cartridge device of FIG. 4B, the cooling element could be placed between the PCBs. It should also be understood that the optical and fluidic interfaces of the optical chips on each card can optionally be approached from opposite sides of the cartridge device.

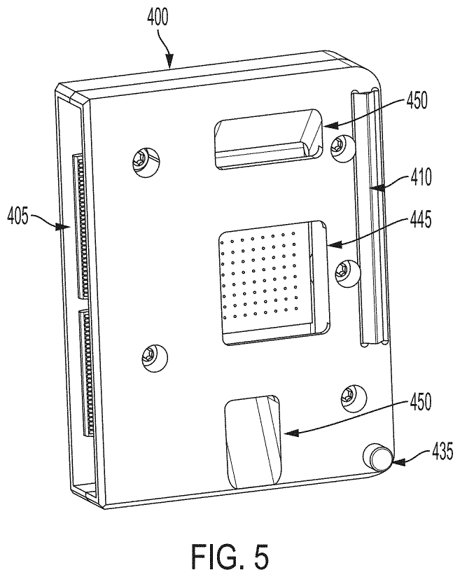

FIG. 5 shows a backside perspective of cartridge 400 of FIG. 4A, including an aperture for entry of cooling air 445 and two apertures for exit of cooling air 450.

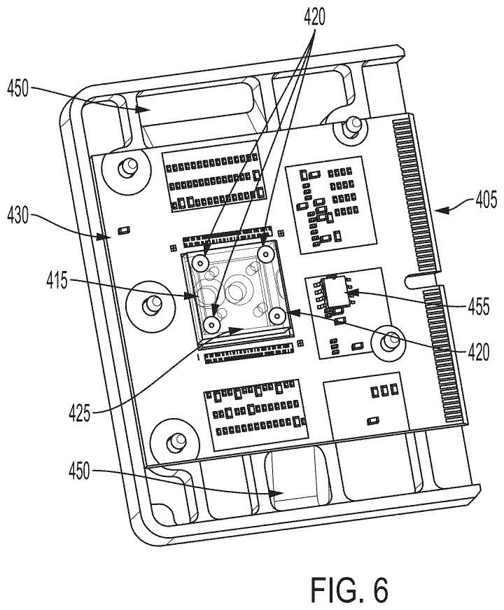

FIG. 6 shows a frontside perspective of the cartridge of FIG. 4A, with the front portion of the cartridge enclosure removed. In addition to the features identified in FIGS. 4A, 4B, and 5, also shown in this drawing is an optional EEPROM 455 that is associated with the printed circuit board and that can be used to store data relating to the various components of the cartridge.

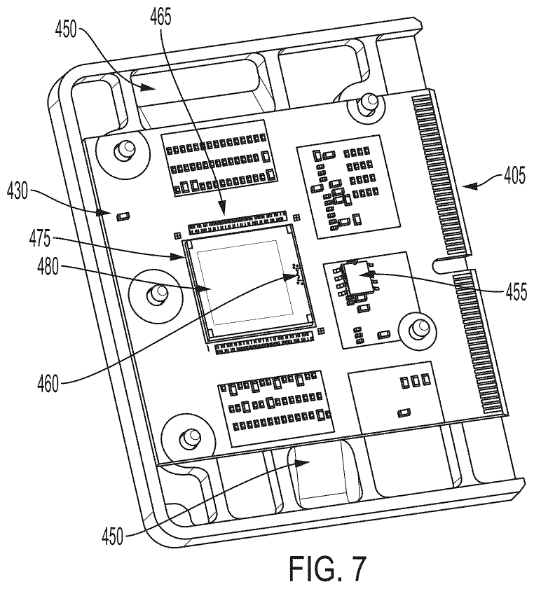

FIG. 7 shows another frontside perspective of the device of FIG. 4A, in this case with both the front portion of the cartridge enclosure and the flow cell removed. In addition to the features identified in the previous drawing, shown in this drawing is an optical port 460 on the multiplexed optical chip, an optical detector layer 475, which is typically a CMOS sensor, and an active sequencing region 480, which comprises of a plurality of reaction regions for nucleic acid sequencing. Wire bond pads 465 on the printed circuit board are typically electronically connected to the outputs from the optical detector layer.

As just described, the nucleic acid sequencing cartridges of the instant disclosure preferably comprise a flow cell in fluidic connection with the plurality of reaction regions on the multiplexed optical chip. More specifically, the flow cell, which is preferably bonded to the optical chip, enables reagent solutions to be provided to the reaction regions in a controlled manner. The flow cell comprises at least one, but preferably a plurality of, input and output ports that are ducted to fluid ports on top of the cartridge, such that liquid reagents can be introduced into the reaction regions of the multiplexed optical chip from outside the cartridge and optionally even from outside the analytical system. In one embodiment, the flow cell of the cartridge includes an additional port into which an end user could pipette a sample, thus decreasing dead volume and minimizing the possibility of sample cross-contamination within an instrument.

In some embodiments, the instant nucleic acid sequencing cartridges comprise features to minimize and/or protect the components from electrostatic discharge (ESD), which can arise from the handling of an electronic device, such as a nucleic acid sequencing cartridge comprising a multiplexed optical chip, by an end user. ESD can be controlled in a variety of ways, as is understood in the art. For example, the chip can be enclosed within an ESD-dissipative plastic. Such enclosures are well known in the art of video game cartridge manufacture. Alternatively, the inside of a cartridge surrounding the packaged device can be metallized, thus creating a Faraday cage or shield to protect the enclosed components. In yet another alternative, all of the cartridge pins can be shorted together via a low-resistance foam that is removable upon insertion of the cartridge into the analytical system.

It is understood that the nucleic acid sequencing cartridges of the instant disclosure will also include an optical coupling interface to inject optical energy into the waveguides of the multiplexed optical chip. An exemplary optical port 460 is illustrated in the device of FIG. 7. The optical port is typically located on the top surface of the multiplexed optical chip, although other configurations should be considered within the scope of these devices. The optical port is preferably covered by a shield, or other protective covering, whenever the device is removed from the analytical system. The shield serves to prevent dust and other contaminants from entering the optical port. In preferred embodiments, the shield is passively actuated as the cartridge is inserted into the analytical system, as would be understood by those in the mechanical arts. Although not shown in FIGS. 4 and 5, the openings (also referred to as apertures) in the cartridge enclosure providing access to the electronic connector or connectors, the thermal conductor or conductors, and the flow cell or other fluid connector or connectors, can also be covered by retractable or removable protective shields when not in use. The shields can be designed so that they are passively retracted as the cartridge is inserted into an analytical instrument. In some embodiments, one or more of the apertures are covered with a single-use protective foil. The protective foil prevents contamination of the interior of the cartridge prior to insertion of the cartridge into an analytical instrument and is typically manually removed from the cartridge by an end user prior to use.

The instant nucleic acid sequencing cartridges are preferably designed so that any excitation light not launched into the waveguides of the multiplexed optical chip is efficiently captured by a beam dump associated with the analytical instrument or the cartridge. Such excess optical energy is ideally converted to heat by the beam dump. The analytical instrument may also include an optical pathway, for example fiber optic cables, to direct an optical alignment signal from the multiplexed optical chip to an alignment detector. For example, a fiber optic cable can route some of the diffracted beam to a photodiode for use in inferring the position of the beam relative to the optical chip.

The above-described nucleic acid sequencing cartridges enable single-molecule, real-time (“SMRT”) sequencing with a number of advantages over existing devices and systems. First, because the packaging in these devices is self-contained, there is accordingly no need for a separate cell tray for the multiplexed optical chip. Second, the enclosed devices are safe for an end user to handle directly, without concern for damage from electrostatic discharge or chemical contamination. Third, the flow cell architecture of the device eliminates the need to cap the reagents in the reaction regions with mineral oil or any other protective liquid, thus enabling the possible reuse of the multiplexed optical chips and thus further decreasing the cost of nucleic acid sequencing in these systems. Fourth, inclusion of an optional onboard non-volatile rewritable memory (e.g., an EEPROM chip) in each cartridge device allows cell-based data to be securely maintained without the complexity and lack of reliability of alternative methods for storing such information. Fifth, the design of the flow cell significantly reduces the amount of sample required per sequencing run and further provides for more even, and thus less variable, loading of the sample. Finally, the simplified design and function of the cartridge devices eliminates the need for robotic components in analytical systems relying on these devices, thus reducing the cost and complexity of the systems.

### Flow Cells and Fluidic Manifolds for Sample and Reagent Delivery

In another aspect, the instant disclosure provides novel flow cells for the delivery of nucleic acid sequencing samples and reagents to the plurality of reaction regions in the active sequencing area of a multiplexed optical chip. Traditional chip-loading methods can be inefficient and uneven. Although flow cells for loading analytical devices, including multiplexed optical chip devices, are known, where these devices have square or rectangular shapes, loading at the corners of the devices can be especially inefficient and uneven.

The instant inventors have addressed at least some of the inadequacies of current flow cell performance by creating the novel designs described herein. In these flow cells, a flow cell chamber covers the sequencing region of the multiplexed optical chip, thus delivering liquid samples and reagents from an input port or ports on the flow cell to the plurality of reaction regions on the chip. The flow cell optionally includes at least one larger-bore pathway, also called a trunk line, to facilitate removal of air bubbles from the flow cell. The exact dimensions of the trunk line can be adjusted as desired to maximize the likelihood that any air bubbles in the liquid sample or reagent will be diverted to the trunk line rather than to the sequencing region of the chip. The dimensions of the trunk line may depend, for example, on the specific composition of the liquids used in the flow cell, as well as on the materials used to fabricate the flow cell and the chip. In specific embodiments, the flow cell includes at least two larger-bore pathways or trunk lines. In even more specific embodiments, the flow cell can include three, four, or even more larger-bore pathways or trunk lines.

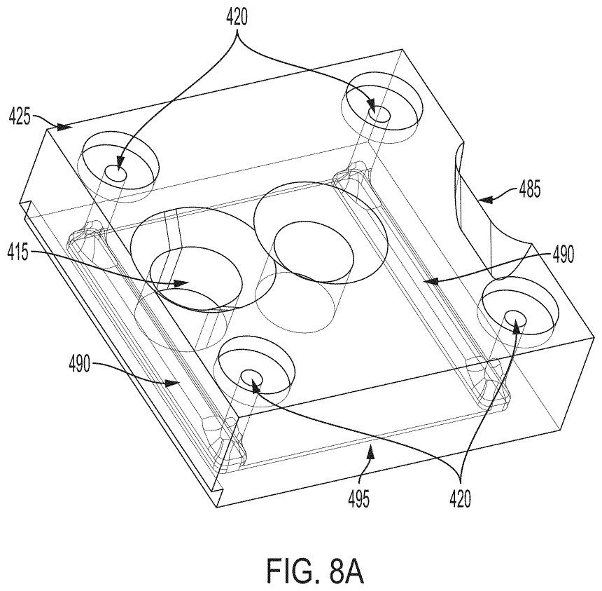

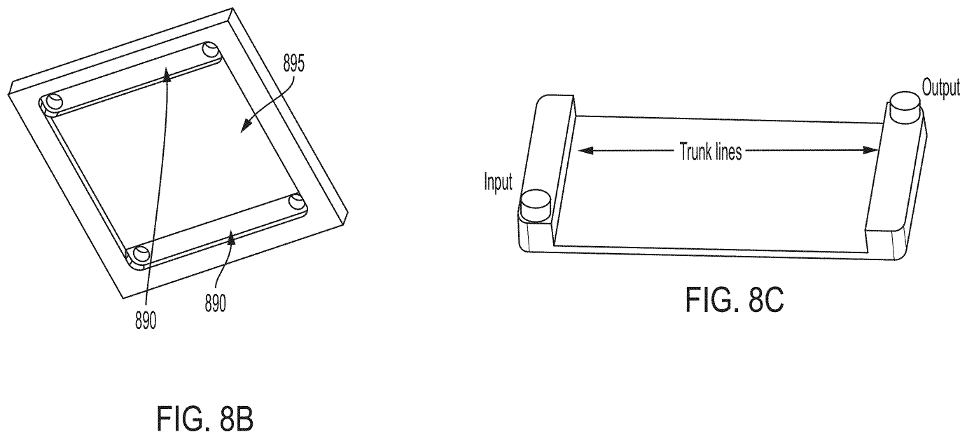

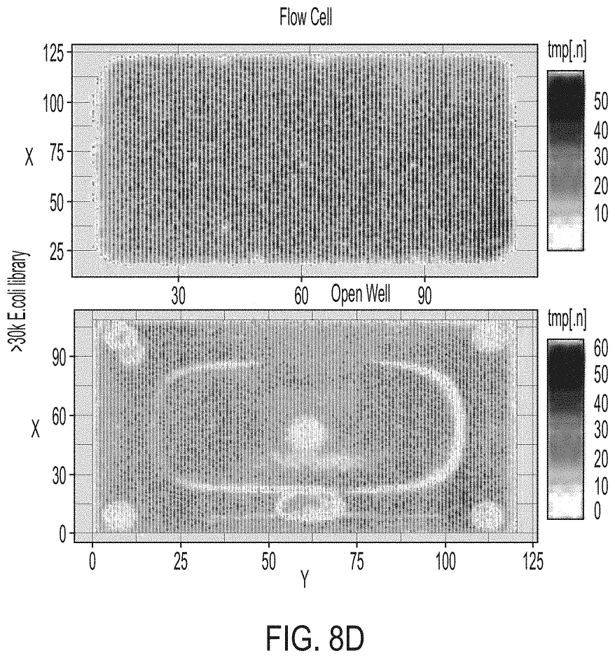

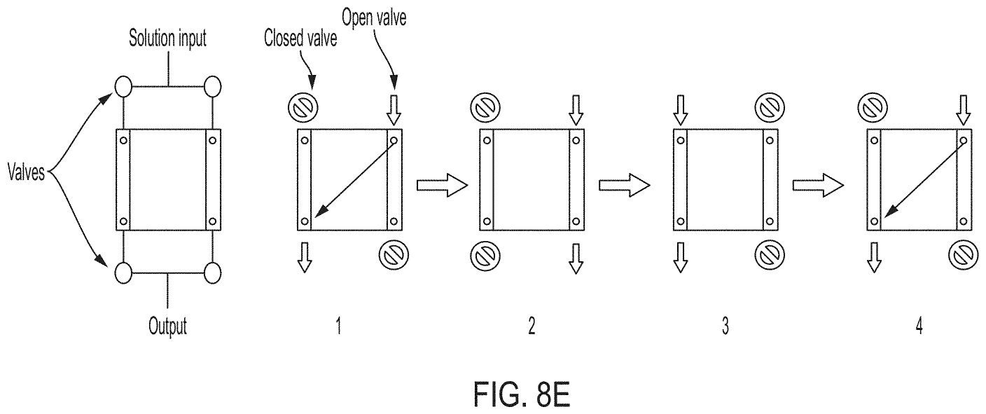

As illustrated in the exemplary drawings of FIGS. 4 and 6, the flow cell is preferably positioned to cover the active sequencing region of a multiplexed optical chip. A more detailed illustration of an exemplary flow cell 425 is provided in FIG. 8A, where the fluidic ports 420 and alignment feature 415 are specifically identified. Also shown in this drawing is a cutout surface 485 on the flow cell that provides access for an excitation optical source to the optical port on the multiplexed optical chip. Two fluidic trunk lines 490 are also shown in FIG. 8A. Each trunk line runs between an input fluidic port and an output fluidic port, and the trunk lines can thus be used to purge air bubbles from the system as the flow cell is being filled by liquid. The air-purging features of this design will be described in more detail below. The trunk lines are also in fluidic connection with a shallower recess in the flow cell, the flow cell chamber 495, that covers the active sequencing region on the optical chip and that provides a fluid pathway for samples and reagents from the sample reservoir and input ports of the flow cell to the plurality of reaction regions on the chip.

It should be understood that fluidic ports 420 are preferably associated with rubber O-rings, or another suitable sealing element, to provide a significantly leak-free fluidic connection between the nucleic acid sequencing cartridge and the fluidic delivery components of the analytical instrument. The O-rings are not shown in the fluidic ports 420 of FIG. 8A, in order to illustrate in more detail the preferred counterbore structure of the fluidic ports in this flow cell device. The O-rings, or other sealing elements associated with the fluidic ports, are compressed after the device cartridge is inserted into the analytical instrument, and as the fluidic manifold is clamped down by a damper motor on the instrument.

FIG. 8A also illustrates another preferred feature of the fluidic devices of the instant disclosure, specifically the alignment feature 415. This feature, which is preferably configured as a hole-and-slot interface on the top surface of the flow cell, is designed to mate with at least one dowel on a fluidic manifold of the analytical instrument, after the device cartridge has been inserted into the instrument, and as the fluidic manifold is clamped down on the flow cell. The mating of these two surfaces ensures a reasonable initial coarse alignment of the cartridge device in the analytical instrument upon insertion and engagement of the cartridge and the instrument with one another. Ideally, the alignment feature provides alignment in two directions (e.g., x and y) and with a further rotational alignment component. A cam-driven mechanism on the analytical instrument can be used to clamp and unclamp the fluidic manifold from the sequencing cartridge as it is inserted and removed from the analytical instrument. Clamping of the fluidic manifold onto the flow cell of the packaged nucleic acid sequencing device compresses the O-rings, or other comparable sealing mechanism, between the fluidic connections and thus prevents leaks as the sequencing cartridge is engaged.

The bottom surface of another exemplary flow cell is illustrated in FIG. 8B, where trunk lines 890 have a depth of approximately 500 μm relative to the perimeter of the flow cell and are approximately 1.5 mm wide. Flow cell chamber 895 has a depth of approximately 200 μm relative to the perimeter of the flow cell. As shown in FIGS. 8A and 8B, the flow cell chamber is preferably rectangular in shape, with an input fluidic port and an output fluidic port positioned over adjacent corners of the rectangle, and with fluidic trunk lines connecting the input and output ports. This configuration minimizes formation of air bubbles as the fluidic reagents enter the flow cell chamber and maximizes filling of the plurality of reaction regions in the sequencing area of the multiplexed optical chip below the flow cell chamber. The 4-port design of the flow cell thus allows for automatable priming/filling of the flow cell while eliminating bubbles from the system. It thereby facilitates uniform wetting, filling, and washing of the underlying sequencing region on the multiplexed optical chip as the fluidic reagents pass through the flow cell.

FIG. 8C shows a top view of an exemplary 2-port flow cell. The input port is in the lower left corner of the flow cell and is in fluid connection with a trunk line that extends along the left-most edge of the flow cell. The output port is in the upper right corner of the flow cell and is in fluid connection with a trunk line that extends along the right-most edge of the flow cell. The two trunk lines are in fluid connection with a flow cell chamber that extends between the trunk lines. FIG. 8D shows heat maps of a multiplexed optical nucleic acid sequencing chip (a SMRT cell) that was loaded either using the two-port flow cell of FIG. 8C (top) or a traditional open-well loading process using a pipette (bottom). As is clear from a comparison of the heat maps, the optical chip loaded using the flow cell displays a higher and more uniform level of loading than the chip loaded using the standard open-well method.

An exemplary filling sequence for a flow cell with two input ports and two output ports is illustrated in FIG. 8E. In this example, the flow of fluids through the input and output ports at the four corners of the flow cell is independently controlled by four fluidic valves, as shown in each of the drawings. The two input ports are positioned at the top corners of each flow cell in the drawings, and the two output ports are positioned at the bottom corners of each drawing, although it may be advantageous for the input ports to be positioned at the bottom of the device in real space, in order to take advantage or the propensity of air bubbles to rise to the surface of a liquid. As shown at time period 1 of FIG. 8E, the right input valve and the left output valve are initially opened, and the other two valves are closed, so the fluid flow generally occurs across the device as shown by the diagonal arrow, but air bubbles are trapped in the corners nearest the closed valves. At time period 2 of FIG. 8E, the input and output valves on the right side are both opened, and the input and output valves on the left side are both closed, thus flushing air bubbles from the right trunk line. At time period 3 of FIG. 8E, the valve positions are reversed, with the input and output valves on the left side both opened, and the input and output valves on the right side both closed, thus flushing air bubbles from the left trunk line. Finally, at time period 4 of FIG. 8E, the valve positions are returned to their status at sequence 1, thus allowing liquid within the flow cell to re-equilibrate.

The flow cells of the instant disclosure can be fabricated from any suitable material, provided that the material is compatible with the liquid reagents used in the nucleic acid sequencing reactions and that the material displays other suitable chemical, physical, and optical properties. In some embodiments, the material can be glass or crystalline silicon, although the brittleness of these materials may be considered disadvantageous in some situations. In addition, the opacity of crystalline silicon can preclude the bonding of such a flow cell to the optical device using a UV-curable adhesive. In some embodiments, the flow cells can be fabricated from a clear material, such as a clear glass or a clear plastic material. In specific embodiments, the material is a plastic material, for example a flexible clear plastic material. In preferred embodiments, the flow cells can be fabricated from an acrylonitrile butadiene styrene (ABS) plastic, preferably a UV-clear ABS plastic. Alternatively, the material can be polystyrene, acrylic, glass, polyether ether ketone (PEEK), or the like. In some embodiments, the material is a coated material, such as a parylene-coated ABS, or another suitable coated material.

The flow cells can preferably be bonded to the detector layer, typically a CMOS sensor layer, of the multiplexed optical chip. As will be described in more detail in a later section, the flow cells are most preferably bonded to the detector layer using a UV-cure adhesive. Such an adhesive is advantageous for these purposes, because the curing can be performed at a relatively low temperature, where the potential damage to heat-sensitive components in the plurality of reaction regions (e.g., biotin) is minimized. A UV-cure adhesive also minimizes the need for solvents or other noxious agents that may inhibit or inactive reagents used in the sequencing reactions. When a UV-cure adhesive is used for the bonding, it is generally preferable that the flow cells be fabricated from a UV-transparent material.

The just-described flow cells offer a number of advantages in the loading of multiplexed optical chips for nucleic acid sequencing compared to existing technologies. For example, they enable a simpler instrument interface and workflow than current approaches with open wells, which require a pipetting robot to fill the reaction regions of an optical chip. In addition, flow cells require reduced overall sample volumes, including a reduced input of sample nucleic acids and reduced volumes of other reagents, thus resulting in a lower cost per sequencing run. Importantly, they improve uniformity in loading of an optical chip and, because they do not require an overlay of oil, they will facilitate reuse of expensive sequencing chips.

As mentioned above, the top surface of the flow cell is preferably designed to engage with a fluidic manifold, which may also be referred to as a fluidic bulkhead or fluidic clamper. The fluidic manifold can be associated with the analytical instrument that is used for nucleic acid sequencing, or it can be part of a separate fluidics system that is used more specifically to load liquid reagents into the optical sequencing devices prior to insertion of the devices into the analytical instrument. As mentioned above, the engagement between the fluidic manifold and the flow cell creates a fluidic connection that enables delivery of liquid reagents from the instrument to the active sequencing region on the multiplexed optical chip.

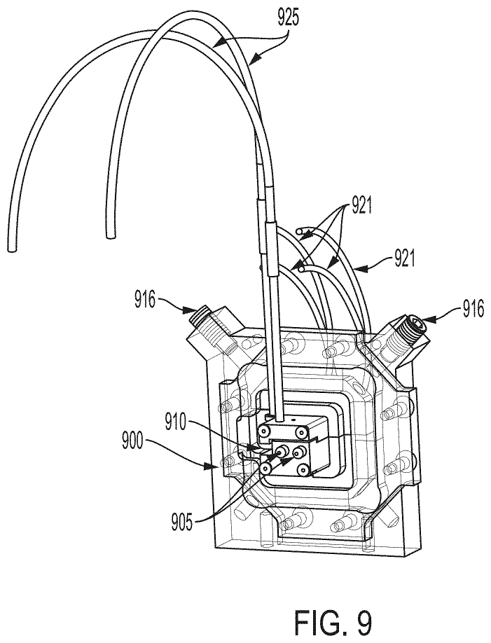

An exemplary fluidic manifold 900 is illustrated in FIG. 9, where the surface coming out of the plane of the page is designed to interface with the top surface of a flow cell, for example the flow cell design illustrated in FIGS. 4, 6, and 8A. Alignment dowels 905 are configured to engage with an alignment feature on the flow cell, for example, a hole and slot on the surface of the flow cell. Also shown in FIG. 9 is a laser beam dump 910 for capturing reflected excitation energy (i.e., excess optical energy) and converting it to heat, two spring-loaded adjustors 916 to accommodate coarse alignment between the analytical instrument and the cartridge, four fluid transfer tubes 921 to transfer liquid reagents to and from the two input port and two output ports, and two optical fibers 925 for assisting in alignment of the laser. It should also be understood that the laser beam dump and the various alignment features may be necessary only where the fluidic manifold is part of an optical instrument that performs the sequencing reaction. Where the fluidic manifold is used only to deliver liquid reagents to sequencing devices, it may not be necessary to include such alignment features in the manifold.

It should also be understood that in preferred embodiments, the fluidic manifold has two main functional pieces that are movable relative to one another. In the exemplary fluidic manifold shown in FIG. 9, an outer frame of the manifold is connected to the analytical instrument, and an inner frame is designed to slide freely relative to the outer frame, but to have its movement modulated by four springs, where the tension of two of the springs can be pre-loaded by the adjustors 916. In the exemplary fluidic manifold of FIG. 9, the springs at the corners diagonally opposed to the preloaded adjustors 916 are not shown.

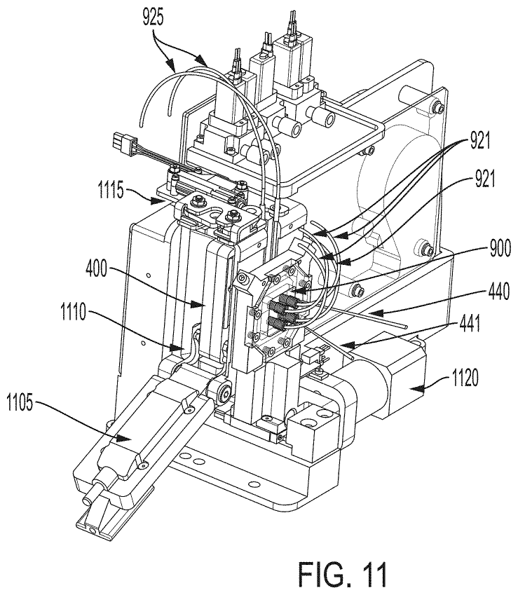

The optional optical fiber (or fibers) 925 shown in FIGS. 9 and 11 can be used to capture reflections of the beam off the surface of the chip. The reflected light can be routed to a photodiode, or the like, the output from which can be used by software in the analytical instrument to infer the location of the laser relative to the chip and thereby control coarse alignment with the optical input coupler. In some embodiments, the fluidic manifold may include only a single optical fiber to assist in alignment of the laser, or the alignment may be performed by an alternative mechanism, for example by including a photodiode mounted in the fluidic damper. In this case, optical fibers in the fluidic manifold may not be necessary.

### Cooling Systems for the Packaged Nucleic Acid Sequencing Devices

In some embodiments, the instant nucleic acid sequencing cartridges, packaged devices, or analytical systems comprising these cartridges or devices, additionally comprise features to dissipate heat. Heat is generated in the analytical systems comprising the instant cartridges or packaged devices, both from the optical source, for example a laser optical source, and also from the CMOS sensors used in these systems. Since the reagents used in nucleic acid sequencing are typically sensitive to high temperatures, it can be important to provide for the dissipation of heat from the multiplexed optical chips of the instant packaged devices and from the analytical systems more generally.

Thermal control within a packaged device can be provided in several ways. In some embodiments, a low-cost thermoelectric cooler (TEC) and heatsink can be included in a cartridge surrounding the packaged device. In other embodiments, the TEC is included in the analytical instrument, at a remote location from the packaged device, and thermal contact is established between the TEC and the multiplexed optical chip via an Indium pad or the like. Use of a remote TEC may be advantageous from a cost perspective, but such a configuration can depend on the accurate and reproducible measurement of temperature at an area of interest on the optical chip. In preferred embodiments, an impinging jet of cooled air is blown in from a blower fan associated with the analytical instrument and is used to cool the CMOS sensor. The cool air can enter the cartridge or packaged device at an entry port, for example aperture 445, as shown in the cartridge of FIG. 5, and waste heat can emerge from exhaust ports in the cartridge, for example from the two apertures 450, as shown in FIGS. 5-7.

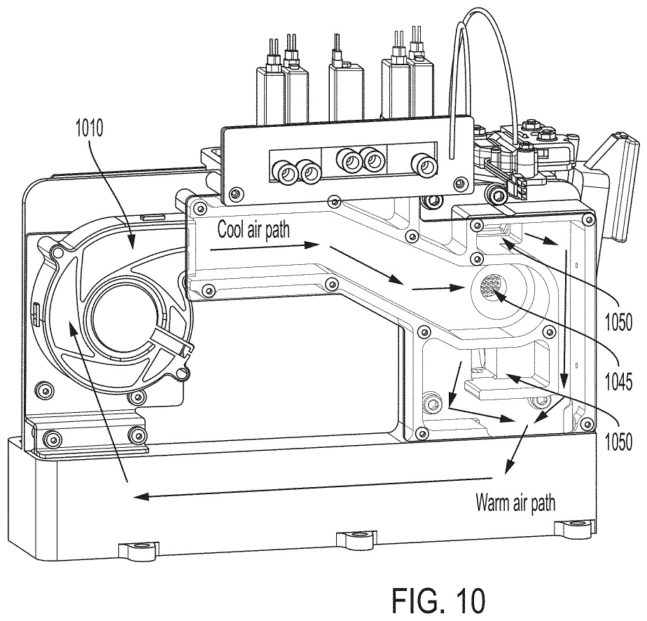

An exemplary cooling system for the cartridges and packaged devices of the instant disclosure is illustrated in FIG. 10. In this system, the cartridge of FIG. 5 is inserted into the analytical instrument so that air entry aperture 445 and air exhaust apertures 450 are aligned with ports 1045 and 1050 of the cooling system, respectively. A blower fan 1010 provides cool air through the packaged device, as indicated by the arrows through the “cool air path” and the “warm air path”. Not shown is a TEC that can be attached to a surface of the blower fan to transfer heat away from the multiplexed optical chip via the cooling system. In some embodiments of the instant cooling systems, a dehumidification membrane (not shown in FIG. 10) can be included within the air flow to remove humidity from the circulating air, and thus to ensure that there is no condensation within the system.

### Analytical Instruments and Systems for Nucleic Acid Sequencing

In another aspect, the disclosure provides complete analytical systems for use in automated nucleic acid sequencing, in particular single molecule, real-time sequencing, that comprise an analytical instrument and any of the nucleic acid sequencing cartridges or packaged devices described above. The cartridges and packaged devices used in these systems preferably comprise a multiplexed optical chip that is attached to a printed circuit board, as previously described. Even more preferably, the multiplexed optical chip and the printed circuit board are surrounded by a protective enclosure, for example the above-described cartridge enclosures.

As described above, the nucleic acid sequencing cartridges and packaged devices can, in preferred embodiments, be removably inserted into the analytical instrument, and the analytical instrument can include other desired optical, electronic, fluidic, mechanical, or thermal components. Liquid sequencing reagents can be brought into contact with the cartridges and packaged devices, either before or after the cartridge or packaged device has been inserted into the instrument. Where liquid reagents are delivered to the cartridge or packaged device after it has been inserted into the analytical instrument, the instrument preferably includes pumping and other fluidic components to direct the liquids to the reaction regions on the multiplexed optical chip in a controllable manner. For example, the instrument can include a syringe pump, or the like, to deliver liquid reagents to the reaction regions.

The analytical instrument can provide electronic signals to an associated cartridge or packaged sequencing device and can receive electronic signals from detectors or other electronic components within the cartridge or device. The instrument typically includes one or more computers to manipulate, store, and analyze data obtained from the device. For example, the instrument can have the capability to identify the order of added nucleotide analogs for the purpose of nucleic acid sequencing. The identification can be carried out, for example, as described in U.S. Pat. No. 8,182,993, and U.S. Patent Application Publication Nos. 2010/0169026 and 2011/0183320 which are each incorporated herein by reference for all purposes in their entireties.

In preferred embodiments, the analytical systems of the disclosure comprise any suitable cartridge or packaged nucleic acid sequencing device, as described herein, and at least one optical source for providing illumination light to the one or more waveguides of the packaged device or devices. More preferably, the analytical systems further comprise an electronic system for providing voltage and current to the detector and for receiving signals from the detector and/or a computer system for analyzing the signals from the detector to monitor the analytical reaction, for example, to obtain sequence information about a template nucleic acid. In other preferred embodiments, the analytical systems of the instant disclosure comprise a cooling system, for example, any of the cooling systems described above, that removes heat from the multiplexed optical chip and/or from other components of the system. In some embodiments, the cooling system comprises a blower fan. In some embodiments, the cooling system comprises a thermoelectric cooler.

An exemplary analytical system comprising the above features is illustrated in FIG. 11. In this system, a cartridge-type packaged nucleic acid sequencing device 400 is already inserted into the instrument. A card-edge connector (not shown) on the printed circuit board of device 400 is physically engaged with a compatible connector in the instrument to provide a suitable electronic connection, either by manual pressure from a user as the cartridge is inserted into the instrument, or by pressure from door 1105 or another suitable mechanical component associated with the instrument. As mentioned above, an LED on the packaged device, or another suitable signal, can provide feedback to the user that the cartridge has been correctly inserted into the instrument. One or more hooks 1110 on the instrument can be configured to engage with one or more ejection features on the cartridge (not shown) to facilitate the ejection of the cartridge device from the instrument. A safety interlock 1115 associated with the latching mechanism of the door may optionally be included in the instrument to prevent accidental exposure of a user to laser or other optical radiation from the instrument. It should also be understood that one or more protective covers on the cartridge enclosure (not shown) may reversibly open as the cartridge is inserted into the analytical instrument. As described above, such covers can be used to protect sensitive components of the cartridge device from undesirable electrical, mechanical, or chemical exposure prior to insertion of the device into the instrument.

Also shown in FIG. 11 is an input optical beam 440, which is directed from an optical source associated with the analytical instrument to an optical coupler on the multiplexed optical chip within the cartridge device, a reflected beam 441, which represents optical energy that is not coupled into the optical chip but instead reflects off of the device, and a fluidic manifold 900 and the associated fluidic manifold damper motor 1120. The fluidic manifold is driven into position against the flow cell of the cartridge device by a spring mechanism upon insertion of the cartridge into the analytical instrument in this exemplary system. The damper motor is configured to move the fluidic manifold off of the flow cell of the cartridge device prior to ejection of the cartridge from the instrument. The damper motor is preferably a stepper motor with an attached gear-reduction mechanism for driving an attached cam. Flexible O-rings at each of the fluidic port couplings are compressed as the manifold clamps against the flow cell, thereby creating a tightly sealed fluidic interface between the fluidic manifold and the flow cell. Four fluid transfer tubes 921 and two optical alignment fibers 925 are illustrated in the exemplary system of FIG. 11, although it should be understood that the number and configuration of these components could differ, depending on the system.

As also shown in FIG. 11, the cartridge-type device can be oriented vertically in the instrument. Such an orientation simplifies insertion and removal of the cartridge. It also minimizes the impact of leaks and facilitates the escape air bubbles upward through the trunk lines of the flow cell rather than remaining trapped in the sequencing region of the multiplexed optical chip.

The optical source used in the instant analytical systems can be any suitable optical source, as would be understood by those of ordinary skill in the relevant art. Optical sources that emit in the visible wavelength range are particularly useful for the analysis systems of the present disclosure, for example optical sources that emit between 450 nm and 700 nm or from 500 nm to 650 nm In some embodiments, the instant systems can include more than one optical source.

In preferred embodiments, the optical source is a laser source. Any suitable type of laser can be used for the instant systems. In some cases, solid state lasers are used, for example, III-V semiconductor lasers. Recently, progress has been made in producing solid state lasers that emit in the desired wavelength range. Particularly useful lasers are GaInN solid state lasers. Lasers suitable for use in the disclosed systems, including GaInN lasers, are described, for example in Sizov et al., “Gallium Indium Nitride-Based Green Lasers,” J. Lightwave Technol., 30, 679-699 (Mar. 1, 2012), Nakamura, et al. “Current Status and Future Prospects of InGaN-Based Laser Diodes”, JSAP Int. No. 1, January, 2000, Jeong et al. Nature, Scientific Reports, “Indium gallium nitride-based ultraviolet, blue, and green light emitting diodes functionalized with shallow periodic hole patterns”, DOI: 10.1038, and Tagaki et al., “High-Power and High-Efficiency True Green Laser Diodes”, SEI Tech Rev, No. 77, October 2013; which are each incorporated by reference herein for all purposes in their entireties.

In some embodiments, the optical source is a light emitting diode, for example a superluminescent light emitting diode. In some embodiments, the optical source is a vertical-cavity surface-emitting laser, or other comparable optical device.

In specific embodiments of the analytical instrument, the optical source can be configured to be replaceable by an end user, thus decreasing upkeep, maintenance, and repair costs for the user. More particularly, all of the optics in these sequencing systems, including the laser(s) and the entire beam train, can be encapsulated into a single optics box or module. This box can be removable and replaceable directly by an end user to facilitate inexpensive, rapid self-servicing of the instrument.

In one embodiment of such a system, the user lifts a cover on the instrument, disconnects a single cable, and then removes the optics module from the system. By reversing the previous steps, the user can replace the optics module with a new or rebuilt unit, thus placing the instrument back into service. The defective optics module can be shipped back to the manufacturer for refurbishment or disposal. In some embodiments, the user releases a locking mechanism, for example a turnable knob or twistable cam, on top of the optics module prior to removing the module from the system. In some embodiments, a dovetail connector is used to connect the module to the system instead of, or in addition to, a cable.

In specific embodiments, the optics cartridge can be registered to the instrument by a number of methods, including via a hole and slot or other similar kinematic mounting.

The invention thus makes it practical for an end user to service any and all optical problems that may arise in their own instruments, much in the same way that an end user is able to replace toner and ink cartridges in desktop printing systems. Instrument downtime and costs are accordingly minimized in these systems.

### Bonding Procedures and Bonded Flow Cell Structures to Minimize Bleaching of Sequencing Reagents

In another aspect are provided novel procedures and structures for minimizing the bleaching of sequencing reagents on a packaged device comprising a flow cell. As described above, the flow cells used in the packaged nucleic acid sequencing devices of the instant disclosure are preferably plastic, for example a flexible plastic, and are more preferably a UV-clear plastic, such as ABS plastic. Use of a UV-clear plastic allows the flow cell to be bonded to the detector layer using a UV-cure adhesive, thus enabling the cure to be performed quickly and at a relatively low temperatures, thereby avoiding degradation of temperature-sensitive reagents in the reaction regions of the optical chip. ABS plastic also has advantages in being chemically compatible with the reagents used in nucleic acid sequencing reactions and in being non-brittle. Alternative exemplary materials for the instant flow cells include polyether ether ketone (PEEK), polyethylene terephthalate (PET), Glass Filled PET, and the like.

Although the use of a UV-clear plastic is advantageous from a bonding, chemical, and physical perspective, it can be disadvantageous when an optical chip having an attached flow cell is illuminated, since routing waveguides on the optical chip can release optical energy above the chip, either through scattering or as an evanescent wave, and this released light can result in the photobleaching of fluorescent reagents in the flow cell, as well as increased background fluorescence, for example if excitation optical energy reaches the fluorescent reagents above the chip. In particular, where the routing waveguides pass underneath attachment sites for the flow cell, the clear-plastic material can provide a pathway for the released light to reach fluorescent reagents within the flow cell above the chip and thus photobleach the reagents and/or cause background fluorescence.

The inventors of the instant disclosure have recognized this problem and have designed novel bonding procedures and bonded flow cell structures to avoid these problems. Specifically, the inventors have designed flow cell structures that can block released light from reaching the fluorescent reagents in the flow cell while at the same time allowing sufficient light to pass through the flow cell to cure the adhesive used to bond the flow cell to the multiplexed optical chip.

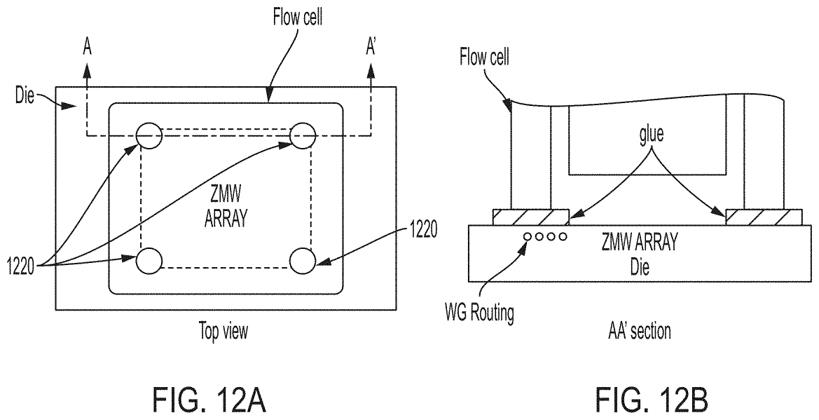

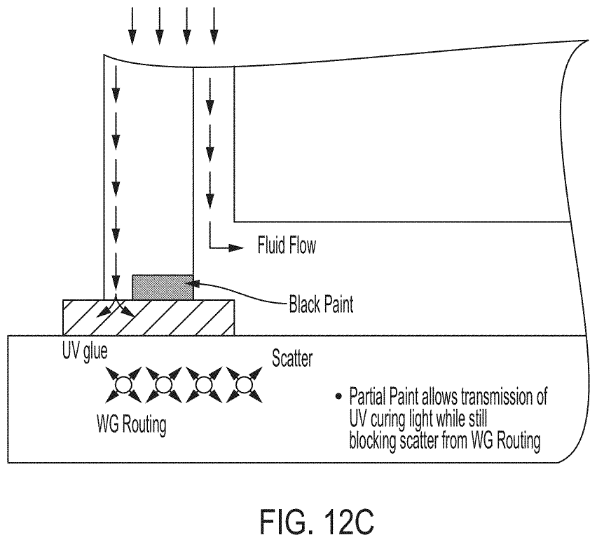

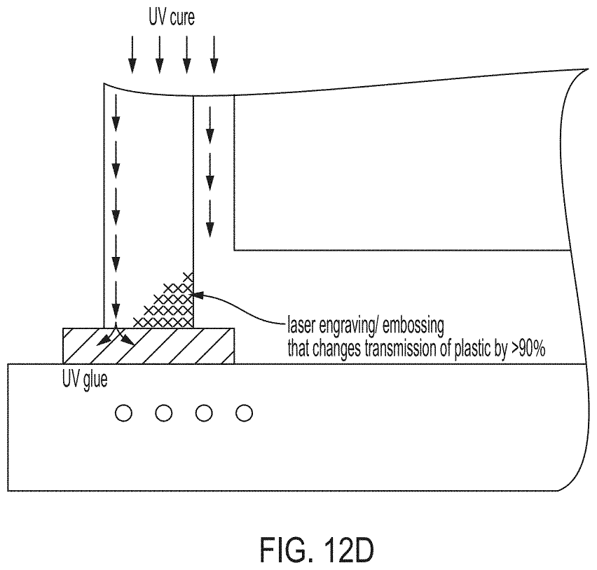

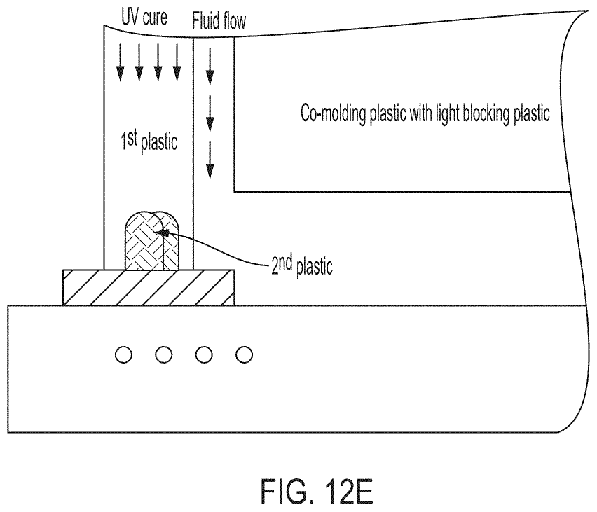

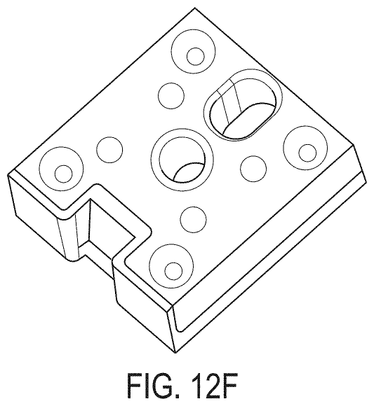

FIGS. 12A and 12B show top and side perspectives, respectively, of a flow cell that has been bonded to an optical chip (“Die”) using a suitable adhesive (“Glue”). The top view shows the positions of four fluidic ports 1220 in the exemplary flow cell and also shows the active sequencing region (“ZMW Array”) of the chip. The side view shows a profile of the flow cell and the position of the adhesive on the surface of the chip. The side view also shows the location of waveguides (“WG Routing”) below the flow cell. The four waveguides illustrated in this particular cross-section deliver light in a direction that is normal to the plane of the cross-section of FIG. 12B, so each waveguide appears as a dot.

FIGS. 12C-12E illustrate three different solutions to the problem of designing a multiplexed optical chip with an attached flow cell, where the flow cell is bonded to the chip with a UV-curable adhesive and where stray light needs to be blocked from passing through the transparent flow cell to the fluorescent reagents above the chip and thus to cause bleaching and background signal.

As shown in FIG. 12C, in some embodiments, the bottom surface of the flow cell is partially coated with a differentially opaque paint or other suitable coating, such that an optical pathway exists for the passage of UV light from above to cure the adhesive (“UV glue”), but little or no optical pathway exists to allow passage of sample excitation light from the waveguide below the surface of the chip to the reagents within the flow cell. In preferred embodiments, the paint or coating is fully transparent to UV radiation and fully opaque to sample excitation light, although partial transparency to UV radiation and partial opacity to sample excitation light can also provide advantages in the design of such flow cells.

FIG. 12D illustrates a variant of the approach shown in FIG. 12C, where instead of a paint or coating, a portion of the bottom surface of the flow cell is modified using laser engraving or embossing to decrease the optical transmission of the treated section of the flow cell for excitation light. In some embodiments, the transmission is decreased by at least 50%, at least 60%, at least 70%, at least 80%, at least 90%, or even more. In specific embodiments, the transmission is decreased by at least 90%. At least a portion of the bottom surface of the flow cell should remain sufficiently transparent to UV light that the UV-sensitive adhesive can be cured by application of a UV cure from above, as shown in the drawing.

FIG. 12E illustrates yet another variant of the approach shown in FIG. 12C. In this example, the flow cell is co-molded with a second plastic, wherein the second plastic is an opaque plastic, and wherein the second plastic is co-molded across at least a portion of the bottom surface of the flow cell. Again, the composition and location of the second plastic in the flow cell significantly decreases transmission of excitation light from the routing waveguides near the surface of the optical chip through the flow cell to the liquid fluorescent reagents within the flow cell but does not significantly block the transmission of UV cure irradiation from above the flow cell to the UV-sensitive adhesive. An exemplary three-dimensional representation of a flow cell comprising a transparent plastic co-molded with a second, opaque plastic is shown in FIG. 12F.

Other variants of the above structures would be understood to solve this problem by those of ordinary skill in the art.

### Fluidic Methods for Improved Sample Loading

In another aspect, the instant disclosure provides novel methods that improve the efficiency and extent of loading of a nucleic acid analytical sample onto a multiplexed optical chip. Whereas nucleic acid samples are typically loaded onto such devices using static loading techniques (e.g., by applying the nucleic acid sample to the device and incubating without further mixing or circulation), these approaches can be inadequate as the size and multiplex of an analytical device increases.

The instant inventors have identified the inadequacy of traditional loading methods and have developed novel approaches for addressing this issue. In particular, one approach has already been described above with respect to novel analytical devices comprising a flow cell feature for delivering samples and reagents to a sequencing chip. As shown above, the use of a flow cell to load a sample chip results in the more efficient loading than is possible using a traditional open-well loading process with a pipette. See, e.g., FIG. 8D.

The loading methods are further improved by solution reflow or recirculation over the active area of an analytical chip device, for example using the flow cell device. Specifically, the loading solution can, for example, be flowed back and forth over the device (i.e., “reflowed”), resulting in a 2× improvement on template loading at very low picomolar concentrations. Furthermore, fully recirculating the sample across the active area surface of the analytical chip, for example by the recovery of sample at an outlet port of the flow cell, and by the subsequent reintroduction of the sample at an inlet port in the flow cell, ideally at a second inlet port in the flow cell, can significantly improve loading of the sample on the analytical chip device.

In some embodiments, the methods of loading may include the step of replenishing the supply of samples and/or reagents either before or during a sequencing run. Such replenishment can be particularly advantageous during long sequencing runs, where the supply of reagents can be depleted during the course of a run.

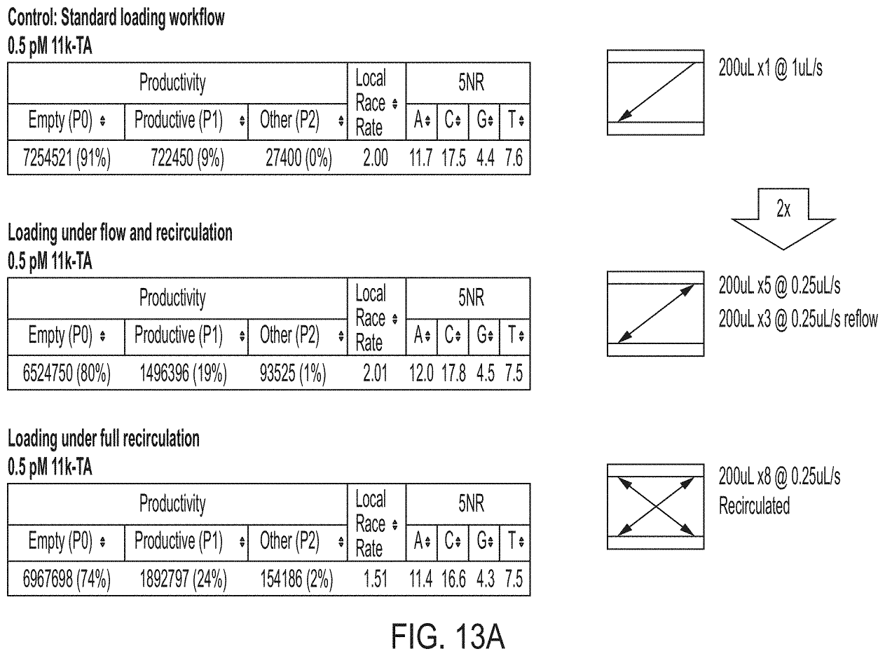

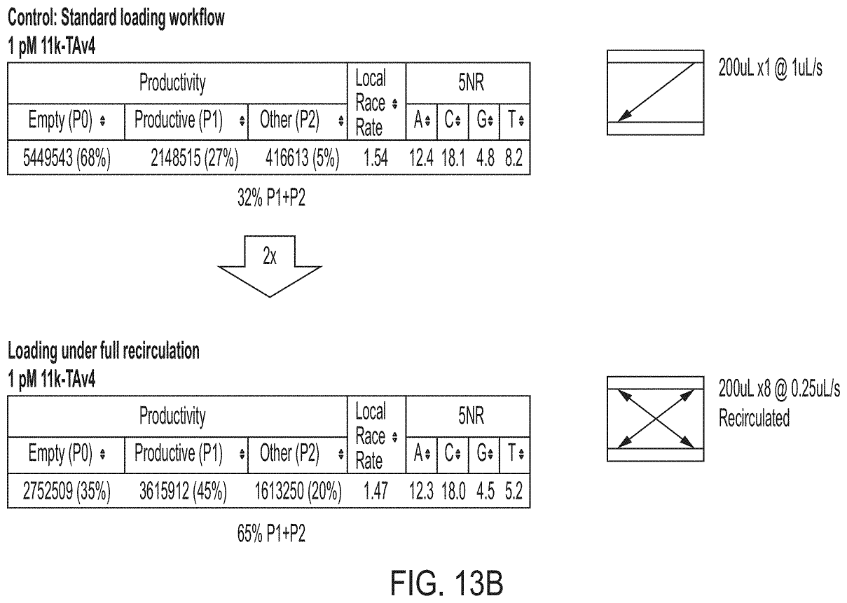

An exemplary loading process in accordance with these aspects of the disclosure is illustrated in FIGS. 13A and 13B. The top panel in each case represents the loading of a 200 μL sample at either 0.5 pM concentration (FIG. 13A) or 1 pM concentration (FIG. 13B) from an inlet port at one corner of an active area on an analytical chip device, and allowing the sample to flow diagonally across the chip device to an outlet port at the opposite corner of the device. The rate of flow was controlled at 1 μL/s. As shown in these figures, the loading of reaction regions on the chip device (which corresponds to non-empty sites) in each case was either 9% (FIG. 13A top) or 32% (FIG. 13B top). If the sample was allowed to “reflow” diagonally back across the device, a loading level of 20% at the 0.5 pM concentration was achieved (FIG. 13A middle). If the sample was allowed to fully recirculate, as illustrated graphically on the right side of each figure, a loading level of 26% at the 0.5 pM concentration (FIG. 13A bottom) and 65% at the 1 pM concentration (FIG. 13B bottom) was achieved. These results demonstrate the advantages provided by the disclosed methods of flowing, reflowing, and recirculating nucleic acid samples across the surface of any of the above-described flow cell devices.

The above flow methods can additionally serve as a method to concentrate nucleic acid samples on an analytical device. Specifically, nucleic acid sample material can be concentrated over a surface of the optical device under flow conditions. Such approaches can be particularly useful in systems that require large sample volumes. For example, the same molar amount of a nucleic acid sample material can be diluted over a large volume and then be re-concentrated over the surface as it is immobilized in the reaction regions of the optical device.

Accordingly, in some embodiments, the methods of loading can comprise the steps described in the following numbered paragraphs:

1. A method for loading an analytical device comprising the steps of:
providing an analytical device comprising:
   a multiplexed optical chip comprising;
      a plurality of reaction regions;
      at least one optical waveguide optically coupled to the plurality of reaction regions;
      an optical coupler optically coupled to the at least one optical waveguide; and
      an optical detector optically coupled to the plurality of reaction regions; and
   a flow cell in fluidic connection with the plurality of reaction regions on the multiplexed optical chip; and
applying a nucleic acid sample to the analytical device;
wherein the nucleic acid sample dynamically flows in a first direction across a surface of the device in fluidic connection with the plurality of reaction regions.
   2. The method of paragraph 1, wherein the nucleic acid sample subsequently dynamically reflows in a second direction across the surface of the device.
   3. The method of paragraph 1, further comprising the step of recirculating the nucleic acid sample across the surface of the device.
   4. The method of paragraph 1, wherein the flow cell comprises at least two fluidic ports.
   5. The method of paragraph 4, wherein the flow cell comprises at least one input fluidic port and at least one output fluidic port.
   6. The method of paragraph 5, wherein the flow cell further comprises at least one trunk line, wherein the at least one trunk line is in fluidic connection with at least one input fluidic port, and wherein the at least one trunk line is configured to direct air bubbles away from the plurality of reaction regions.
   7. The method of paragraph 4, wherein the flow cell comprises at least four fluidic ports.
   8. The method of paragraph 7, wherein the flow cell comprises at least two input fluidic ports and at least two output fluidic ports.
   9. The method of paragraph 4, wherein the at least two fluidic ports are independently controllable by fluidic valves.
   10. The method of paragraph 9, wherein the flow cell further comprises at least one trunk line, wherein the at least one trunk line is in fluidic connection with at least one input fluidic port, and wherein the at least one trunk line is configured to direct air bubbles away from the plurality of reaction regions.
   11. The method of paragraph 1, wherein the flow cell further comprises a physical alignment element.
   12. The method of paragraph 11, wherein the physical alignment element comprises a hole, a slot, or a hole and a slot.
   13. The method of paragraph 1, wherein the flow cell is fabricated from a material that is at least partly transparent to UV radiation.
   14. The method of paragraph 13, wherein the material is a UV-transparent plastic.
   15. The method of paragraph 14, wherein the UV-transparent plastic is an acrylonitrile butadiene styrene plastic.
   16. The method of paragraph 1, wherein the flow cell is fabricated from a material that is at least partly transparent to UV radiation, wherein the flow cell comprises a bottom surface in contact with the multiplexed chip, and wherein the bottom surface is at least partially covered by a material that is at least partly opaque to visible light.
   17. The method of paragraph 16, wherein the material that is at least partly opaque to visible light is a paint, a laser engraved or embossed material, or an opaque plastic material.
   18. The method of paragraph 1, wherein the flow cell is attached to the multiplexed optical chip by a UV-cure adhesive.
   19. The method of paragraph 1, wherein the multiplexed optical chip is attached to a printed circuit board.
   20. The method of paragraph 19, wherein the printed circuit board comprises a connector element in electronic contact with the optical detector.
   21. The method of paragraph 20, wherein the connector element is an edge connector.
   22. The method of paragraph 20, wherein the device further comprises a non-volatile rewritable memory in electronic contact with the connector element.
   23. The method of paragraph 20, wherein the device further comprises a user-observable connection indicator in electronic contact with the connector element.
   24. The method of paragraph 23, wherein the user-observable connection indicator comprises a light-emitting diode.
   25. The method of paragraph 19, wherein the device further comprises an electrostatic discharge protection element.
   26. The method of paragraph 25, wherein the electrostatic discharge protection element comprises an electrostatic discharge dissipative plastic, a metallization, or a low-resistance foam.
   27. The method of paragraph 19, wherein the device further comprises a thermal conductor in thermal contact with the multiplexed optical chip.
   28. The method of paragraph 1, wherein the multiplexed optical chip is surrounded by a protective enclosure.
   29. The method of paragraph 28, wherein the device further comprises a connector element in electronic contact with the optical detector.
   30. The method of paragraph 29, wherein the protective enclosure comprises at least one aperture for access to the connector element.
   31. The method of paragraph 28, wherein the device further comprises a thermal conductor in thermal contact with the multiplexed optical chip.
   32. The method of paragraph 31, wherein the protective enclosure comprises at least one aperture for access to the thermal conductor.
   33. The method of paragraph 28, wherein the protective enclosure comprises at least one aperture for access to the flow cell.
   34. The method of paragraph 33, wherein the at least one aperture is covered by a retractable protective shield.
   35. The method of paragraph 28, wherein the protective enclosure comprises an ejection pin on an external surface of the protective enclosure, wherein the ejection pin is configured for reversible association with an optical sequencing system.

### Fluidic Devices and Methods for Improved Sample Delivery

In some embodiments, the packaged devices and systems of the instant disclosure, including the cartridge-enclosed packaged devices described above, can be loaded with a nucleic acid sample by the end user using improved sample delivery devices, systems, and methods. In particular, these devices, systems, and methods allow for a nucleic acid sample to be delivered directly to the optical chip by the user, thereby minimizing the overall volume of nucleic acid used in an analytical method. The devices, systems, and methods find utility in a variety of applications, including DNA sequencing, RNA sequencing, on-chip PCR, and the like.

In a typical automated nucleic acid sequencing system, the nucleic acid sample is either placed directly into an open well fluid chamber or a flow cell chamber by a user or a robot as part of the instrument workflow prior to a sequencing run. The sample thereby sits on either the user bench or is placed by the user onto the instrument. Such approaches can, however, require relatively large volumes of sample and can result in the relatively inefficient delivery of the nucleic acid sample to the active sequencing region of the analytical device.

The sample delivery approaches disclosed herein allow for overall lower sample volume by being incorporated directly onto the optical chip. The devices and methods thereby additionally enable lower overall system costs (both capital and operating). A general background summary of on-chip microfluidic systems is provided by Rolland et al. (2004) J. Am. Chem. Soc. 126, 2322, which is incorporated by reference herein for all purposes.

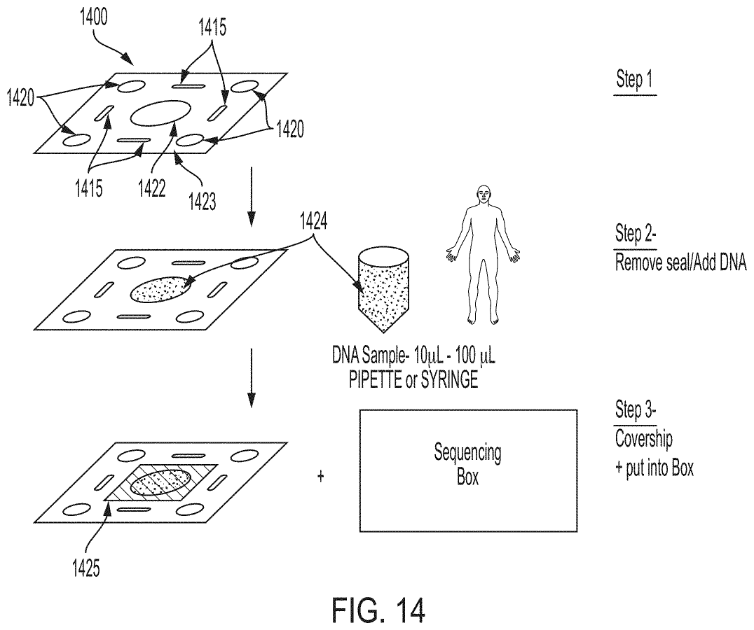

FIG. 14 illustrates an exemplary overall workflow for the delivery of a nucleic acid sample by a user onto an analytical device. As shown in the top drawing, the analytical device 1400 includes a sample capsule 1422 for receiving the nucleic acid sample. The device can also include one or more of the features and components described above, including fluidic ports 1420 and alignment features 1415. The device is preferably covered with a protective seal (for example foil seal 1423, as represented by hash lines covering the surface of the device) and optionally an outer box cover (not shown).

In step 1 of the work flow, an end user, or a robotic equivalent, retrieves a fresh optical chip device 1400 from a suitable storage location or shipping box, and the device is placed on a surface, or other suitable location, for loading. In step 2, the foil seal is removed from the device, and a nucleic acid sample 1424 is placed into sample capsule 1422. As will be described in more detail below, the sample capsule is nested within a sample reservoir housing that is attached to, or fabricated in, a flow cell on the device. By including the sample capsule as part of the analytical device itself, the total volume of sample required for an analysis can be extremely low. For example, a volume of between 10-100 μL can be used for loading such devices, compared to standard volumes of 150-300 μL in systems where the sample compartment is not part of the analytical chip. In step 3 of the work flow, a coverslip, gasket, or other such fluid separation interface 1425 can be added to the top of the sample capsule, and the loaded chip device can then be placed into the instrument, either by the user or by a robotic mechanism. The cover slip feature creates a small barrier between the instrument's pneumatic engagement mechanism and the nucleic acid sample. The function of the cover slip can alternatively be provided by the instrument itself, for example as the loaded chip is inserted into the instrument.

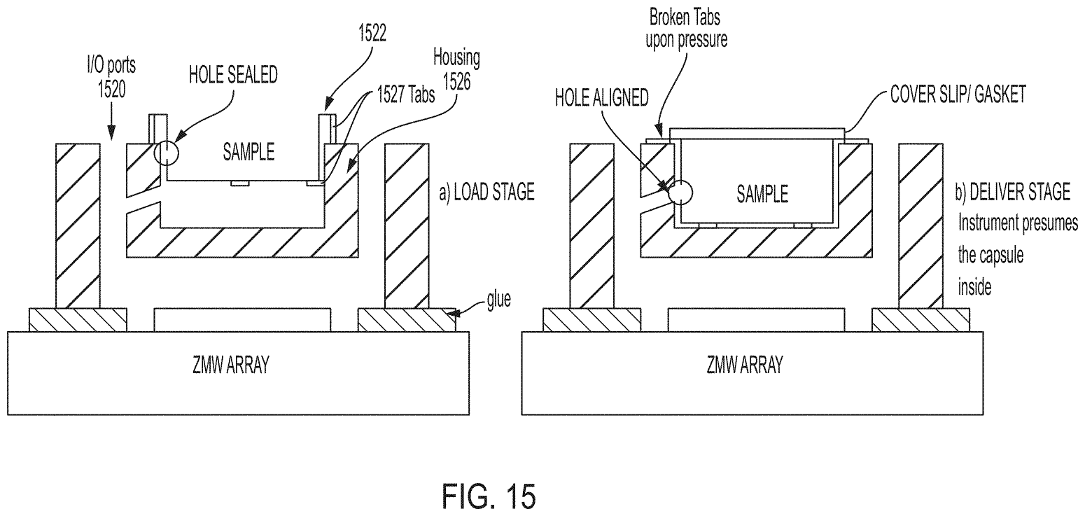

FIG. 15 illustrates an exemplary system for the delivery of a nucleic acid sample from the sample capsule onto the active sequencing region/ZMW array of a chip device using the above-described work flow. In these drawings, an exemplary flow cell, for example any of the above-described flow cells, is shown in a cross-sectional view. In addition to the features described for the flow cells above, the flow cells of the sample-delivery devices also include a sample reservoir housing 1526 and a sample capsule 1522. The upper panel illustrates the “load stage” or “closed” position of the sample capsule, where there is no fluidic connection between the sample capsule and the plurality of reaction regions, and the lower panel illustrates the “deliver stage” or “open” position of the sample capsule, where a fluidic connection has been established between these compartments. As described above, the sample capsule is nested within the sample reservoir. In some cases, an additional material may be co-molded or otherwise included around the sample capsule to create a more effective seal between the capsule and the housing. Such material may be, for example, a soft durometer material such as those used in gaskets (e.g., a fluoropolymer elastomer).

As illustrated in the drawings of FIG. 15, the sample capsule and the sample reservoir housing each contain a “hole” (or another equivalent fluidic opening) that, when aligned, or at least partly aligned, with one another allow for the passage of the nucleic acid sample to the active sequencing region/ZMW array either indirectly via a fluidic I/O port 1520 or directly via a trunk line of the flow cell (see above). Because the sample capsule is initially supported by one or more breakable tabs 1527 in the “load stage” position (FIG. 15, top panel), the fluidic openings in the sample capsule and the sample reservoir housing are not aligned, there is no fluidic connection between the sample capsule and the interior spaces of the flow cell, and the sample cannot pass to the active sequencing region/ZMW array. In the “deliver stage” position (FIG. 15, bottom panel), the fluidic openings of the sample capsule and the sample reservoir housing become aligned, a fluidic connection is formed, and the sample is able to flow to the active sequencing region/ZMW array.

It should be understood that the fluidic openings of the sample capsule and the sample reservoir housing can be aligned by alternative designs and/or mechanisms, for example by a “push-push” mechanism, wherein in a first push, the holes are not aligned, but wherein in a second push, the holes of the sample capsule and the sample reservoir housing become aligned, and thereby enable the sample to flow from the sample capsule to the active sequencing region/ZMW array on the optical chip device.

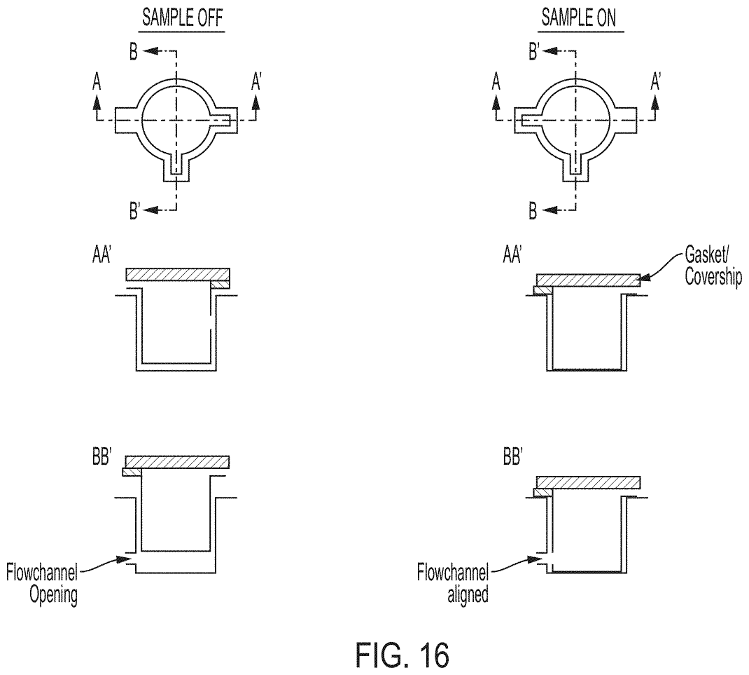

An alternative structural design for the delivery of a nucleic acid sample from the sample capsule onto the active sequencing region/ZMW array of a chip device is illustrated in FIG. 16, where the top drawings represent a view from above the device, and the middle and bottom drawings represent cross-sectional views at the AA′ axis and BB′ axis, respectively. In this example, the fluidic openings of the sample capsule and the sample reservoir housing are aligned not by pushing the sample capsule deeper into the sample reservoir housing, but rather by rotation of the sample capsule within the sample reservoir housing. Specifically, and as shown in the left side drawings of FIG. 16, when the sample capsule is oriented in the “sample off” (or “closed”) position, the fluidic openings in the sample capsule and the sample reservoir housing are not aligned, and the sample therefore cannot flow to the active sequencing region/ZMW array of the optical device. When the sample capsule is oriented in the “sample on” (or “open”) position, as shown in the right side drawings of FIG. 16, the holes in the sample capsule and the sample reservoir housing are aligned, and the sample can freely flow onto the active sequencing region/ZMW array.

It should be understood that in any of the above low-volume sample loading devices, a controllable fluidic connection between the nucleic acid sample in the sample capsule and the plurality of reaction regions on the optical device can be achieved in a variety of ways by the moveable positioning of the sample capsule within the sample reservoir housing. In particular, when the sample capsule and the sample reservoir housing each has a fluidic opening (or “hole”) of similar size and appropriate orientation, positioning of the sample capsule so that the fluidic openings are not aligned prevents a fluidic connection of the two spaces, and a movement of the sample capsule that sufficiently aligns the fluidic openings results in a fluidic connection. As illustrated in the examples of FIGS. 15 and 16, the movement may correspond to pushing the sample capsule into the sample reservoir housing or to rotation of the sample capsule within the sample reservoir housing, but other suitable movements between a compartment containing the sample and a housing surrounding that compartment can result in a suitable fluidic connection.

It should also be understood that even when an open fluidic connection has been established between the sample capsule and the active sequencing region/ZMW array of the optical device, flow of the nucleic acid sample may require either an increased pressure from the sample side, or a decreased pressure from the device side. In specific embodiments, the sample is drawn from the sample capsule to the active sequencing region/ZMW array by the opening of an outlet port in the flow cell and the removing of gas or liquid from the system to draw the sample into the flow cell. In some embodiments, pressure in the system is further controlled by a valve or a vent.

In some embodiments of the above-described sample-delivery devices, at least some of the reagents necessary for an analysis are provided together with the chip cartridge. In the case of a DNA sequencing reaction, for example, the sequencing enzyme and other necessary components can be provided in a “binding kit”. These components can be configured to react with an end user's DNA sample to form a polymerase-template complex, which is subsequently contacted with the reaction regions on the optical chip to immobilize the complex within those regions.

In some embodiments, the above-described devices comprise the features described in the following numbered paragraphs:

1. A packaged nucleic acid sequencing device comprising:
a multiplexed optical chip comprising;
   a plurality of reaction regions;
   at least one optical waveguide optically coupled to the plurality of reaction regions;
   an optical coupler optically coupled to the at least one optical waveguide; and
   an optical detector optically coupled to the plurality of reaction regions; and
a flow cell in fluidic connection with the plurality of reaction regions on the multiplexed optical chip;
wherein the flow cell comprises a sample reservoir housing and a sample capsule that is movably positioned within the sample reservoir housing, and wherein a liquid sample within the sample capsule is not in fluidic connection with the plurality of reaction regions when the sample capsule is in a first position and is in fluidic connection with the plurality of reaction regions when the sample capsule is in a second position.
   2. The packaged nucleic acid sequencing device of paragraph 1, wherein the sample reservoir housing comprises a fluidic opening and the sample capsule comprises a fluidic opening, and the fluidic opening of the sample reservoir housing and the fluidic opening of the sample capsule are in fluidic alignment when the sample capsule is in the second position.
   3. The packaged nucleic acid sequencing device of paragraph 1, wherein the sample capsule is moved from the first position to the second position by pushing the sample capsule into the sample reservoir housing.
   4. The packaged nucleic acid sequencing device of paragraph 2, wherein the sample capsule is held in the first position by a breakable tab.
   5. The packaged nucleic acid sequencing device of paragraph 1, wherein the sample capsule is moved from the first position to the second position by rotating the sample capsule within the sample reservoir housing.
   6. The packaged nucleic acid sequencing device of paragraph 1, wherein the flow cell comprises at least two fluidic ports.
   7. The packaged nucleic acid sequencing device of paragraph 6, wherein the flow cell comprises at least one input fluidic port and at least one output fluidic port.
   8. The packaged nucleic acid sequencing device of paragraph 7, wherein the flow cell further comprises at least one trunk line, wherein the at least one trunk line is in fluidic connection with at least one input fluidic port, and wherein the at least one trunk line is configured to direct air bubbles away from the plurality of reaction regions.
   9. The packaged nucleic acid sequencing device of paragraph 6, wherein the flow cell comprises at least four fluidic ports.
   10. The packaged nucleic acid sequencing device of paragraph 9, wherein the flow cell comprises at least two input fluidic ports and at least two output fluidic ports.
   11. The packaged nucleic acid sequencing device of paragraph 6, wherein the at least two fluidic ports are independently controllable by fluidic valves.
   12. The packaged nucleic acid sequencing device of paragraph 11, wherein the flow cell further comprises at least one trunk line, wherein the at least one trunk line is in fluidic connection with at least one input fluidic port, and wherein the at least one trunk line is configured to direct air bubbles away from the plurality of reaction regions.
   13. The packaged nucleic acid sequencing device of paragraph 1, wherein the flow cell further comprises a physical alignment element.
   14. The packaged nucleic acid sequencing device of paragraph 13, wherein the physical alignment element comprises a hole, a slot, or a hole and a slot.
   15. The packaged nucleic acid sequencing device of paragraph 1, wherein the flow cell is fabricated from a material that is at least partly transparent to UV radiation.
   16. The packaged nucleic acid sequencing device of paragraph 15, wherein the material is a UV-transparent plastic.
   17. The packaged nucleic acid sequencing device of paragraph 16, wherein the UV-transparent plastic is an acrylonitrile butadiene styrene plastic.
   18. The packaged nucleic acid sequencing device of paragraph 1, wherein the flow cell is fabricated from a material that is at least partly transparent to UV radiation, wherein the flow cell comprises a bottom surface in contact with the multiplexed chip, and wherein the bottom surface is at least partially covered by a material that is at least partly opaque to visible light.
   19. The packaged nucleic acid sequencing device of paragraph 18, wherein the material that is at least partly opaque to visible light is a paint, a laser engraved or embossed material, or an opaque plastic material.
   20. The packaged nucleic acid sequencing device of paragraph 1, wherein the flow cell is attached to the multiplexed optical chip by a UV-cure adhesive.
   21. The packaged nucleic acid sequencing device of paragraph 1, wherein the multiplexed optical chip is attached to a printed circuit board.
   22. The packaged nucleic acid sequencing device of paragraph 21, wherein the printed circuit board comprises a connector element in electronic contact with the optical detector.
   23. The packaged nucleic acid sequencing device of paragraph 22, wherein the connector element is an edge connector.
   24. The packaged nucleic acid sequencing device of paragraph 22, wherein the device further comprises a non-volatile rewritable memory in electronic contact with the connector element.
   25. The packaged nucleic acid sequencing device of paragraph 22, wherein the device further comprises a user-observable connection indicator in electronic contact with the connector element.
   26. The packaged nucleic acid sequencing device of paragraph 25, wherein the user-observable connection indicator comprises a light-emitting diode.
   27. The packaged nucleic acid sequencing device of paragraph 21, wherein the device further comprises an electrostatic discharge protection element.
   28. The packaged nucleic acid sequencing device of paragraph 27, wherein the electrostatic discharge protection element comprises an electrostatic discharge dissipative plastic, a metallization, or a low-resistance foam.
   29. The packaged nucleic acid sequencing device of paragraph 21, wherein the device further comprises a thermal conductor in thermal contact with the multiplexed optical chip.
   30. The packaged nucleic acid sequencing device of paragraph 1, wherein the multiplexed optical chip is surrounded by a protective enclosure.
   31. The packaged nucleic acid sequencing device of paragraph 30, wherein the device further comprises a connector element in electronic contact with the optical detector.
   32. The packaged nucleic acid sequencing device of paragraph 31, wherein the protective enclosure comprises at least one aperture for access to the connector element.
   33. The packaged nucleic acid sequencing device of paragraph 30, wherein the device further comprises a thermal conductor in thermal contact with the multiplexed optical chip
   34. The packaged nucleic acid sequencing device of paragraph 33, wherein the protective enclosure comprises at least one aperture for access to the thermal conductor.
   35. The packaged nucleic acid sequencing device of paragraph 30, wherein the protective enclosure comprises at least one aperture for access to the flow cell.
   36. The packaged nucleic acid sequencing device of paragraph 35, wherein the at least one aperture is covered by a retractable protective shield.
   37. The packaged nucleic acid sequencing device of paragraph 30, wherein the protective enclosure comprises an ejection pin on an external surface of the protective enclosure, wherein the ejection pin is configured for reversible association with an optical sequencing system.

### Alternative Fluidic Devices and Methods for Improved Sample Delivery

In another aspect, the disclosure provides alternative improved fluidic devices and methods for sample delivery to an analytical device, such as an optical chip device for nucleic acid sequencing. Unlike the just-described sample-delivery devices, where a nucleic acid sample is added to a low-volume sample capsule directly associated with the flow cell on the surface of the optical chip device, these devices are designed to allow a user to load a sample into a port that is accessible from the exterior of a cartridge that comprises the optical chip device, for example any of the cartridge designs described above. Specifically, in these device embodiments, the user loads a sample through the sample port into a sample reservoir located within the cartridge, and the cartridge is then inserted into the analytical instrument. A pumping system, and interior fluidic connectors, transport the sample from the sample reservoir through the flow cell to the active sequencing region/ZMW array on the optical chip device prior to the sequencing run.

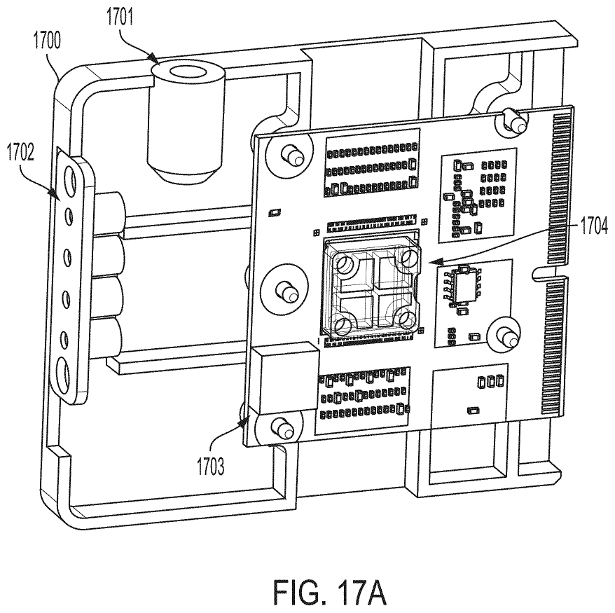

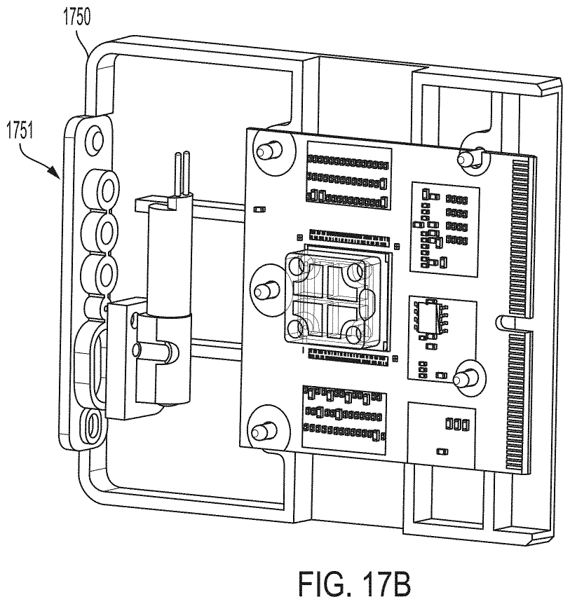

An exemplary cartridge device 1700 with a separate sample reservoir associated with the cartridge is illustrated in FIG. 17A. This drawing highlights locations for the sample reservoir 1701, a bulkhead 1702 with four fluidic connectors, a valve component 1703 attached to the PCB, and a flow cell 1704. The drawing does not, however, show the fluidic connections between these components. FIG. 17B illustrates an alternative cartridge device embodiment 1750, wherein the fluidic bulkhead 1751 is designed to include not just four fluidic connectors but also the sample reservoir and valve functionality. This drawing also omits the fluidic connections within the cartridge device.

In some of the just-described cartridge device embodiments, the device can include a check valve between the sample reservoir and the fluidic port on the flow cell to prevent backflow of reagents into the sample reservoir. In some embodiments, the flow cell can include an additional dedicated port within the flow cell that is separate from the inlet and outlet ports shown in the above flow cell devices and that enables the sample to be loaded directly from the sample reservoir onto the active sequencing region/ZMW array. In some embodiments, the sample reservoir is connected to one of the flow cell inlet or outlet ports through a T-type connection. In any of the above embodiments, flow of sample from the sample reservoir to the active sequencing region/ZMW array on the optical chip device can be driven either by pressurizing the sample reservoir or by depressurizing an outlet port on the flow cell.

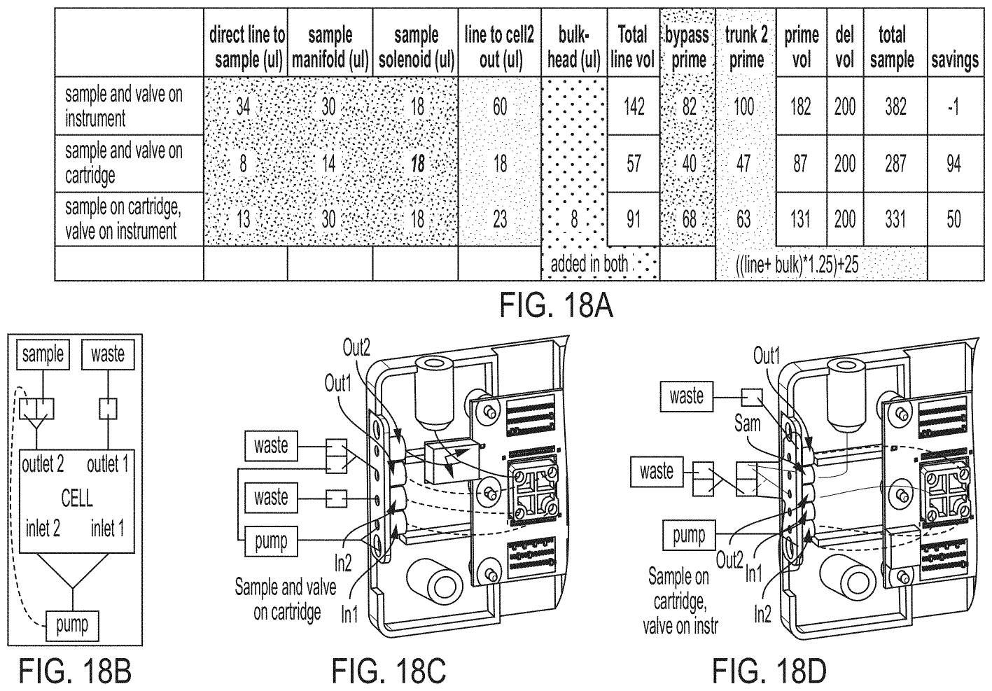

FIG. 18A compares volume requirements for three specific fluidic configurations of the above-disclosed cartridge devices. In a traditional system, as illustrated diagrammatically in FIG. 18B, the sample reservoir and the fluidic valve controlling delivery of the sample to the optical chip device are both located on the instrument. In the cartridge device illustrated in FIG. 18C, the sample reservoir and the fluidic valve are both located on the cartridge, and in the cartridge device illustrated in FIG. 18D, the sample reservoir is located on the cartridge, but the fluidic valve is located on the instrument. The table of FIG. 18A illustrates the advantageous reduction in line volume achieved by locating both the sample reservoir and fluidic valve on the cartridge (row 2) or by locating just the sample reservoir on the cartridge (row 3). In each case, the volumes can be compared to those observed in a traditional device where these components are located on the instrument rather than on the cartridge (row 1).

It will be readily apparent to one of ordinary skill in the relevant arts that other suitable modifications and adaptations to the analytical devices and systems described herein can be made without departing from the scope of the invention or any embodiment thereof.

All patents, patent publications, and other published references mentioned herein are hereby incorporated by reference in their entireties as if each had been individually and specifically incorporated by reference herein.

While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined by reference to the appended claims, along with their full scope of equivalents.

What is claimed is:

1. A nucleic acid sequencing cartridge comprising:
a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions;
wherein the multiplexed optical chip is surrounded by a protective enclosure.

2. The nucleic acid sequencing cartridge of claim 1, wherein the cartridge further comprises a connector element in electronic contact with the optical detector.

3. The nucleic acid sequencing cartridge of claim 2, wherein the protective enclosure comprises at least one aperture for access to the connector element.

4. The nucleic acid sequencing cartridge of claim 1, wherein the cartridge further comprises a thermal conductor in thermal contact with the multiplexed optical chip.

5. The nucleic acid sequencing cartridge of claim 4, wherein the protective enclosure comprises at least one aperture for access to the thermal conductor.

6. The nucleic acid sequencing cartridge of claim 1, wherein the cartridge further comprises a flow cell in fluidic connection with the plurality of reaction regions on the multiplexed optical chip.

7. The nucleic acid sequencing cartridge of claim 6, wherein the protective enclosure comprises at least one aperture for access to the flow cell.

8. The nucleic acid sequencing cartridge of any one of claim 3, 5, or 7, wherein the at least one aperture is covered by a retractable protective shield.

9. The nucleic acid sequencing cartridge of claim 2, wherein the cartridge further comprises a non-volatile, rewritable memory in electronic contact with the connector element.

10. The nucleic acid sequencing cartridge of claim 2, wherein the cartridge further comprises a user-observable connection indicator in electronic contact with the connector element.

11. The nucleic acid sequencing cartridge of claim 10, wherein the user-observable connection indicator comprises a light-emitting diode.

12. The nucleic acid sequencing cartridge of claim 1, wherein the cartridge further comprises an electrostatic discharge protection element.

13. The nucleic acid sequencing cartridge of claim 12, wherein the electrostatic discharge protection element comprises an electrostatic discharge dissipative plastic, a metallization, or a low-resistance foam.

14. The nucleic acid sequencing cartridge of claim 1, wherein the protective enclosure comprises an ejection pin on an external surface of the protective enclosure, wherein the ejection pin is configured for reversible association with an optical sequencing system.

15. The nucleic acid sequencing cartridge of claim 1, wherein the multiplexed optical chip is attached to a printed circuit board.

16. The nucleic acid sequencing cartridge of claim 6, wherein the flow cell comprises at least two fluidic ports.

17. The nucleic acid sequencing cartridge of claim 16, wherein the flow cell comprises at least one input fluidic port and at least one output fluidic port.

18. The nucleic acid sequencing cartridge of claim 17, wherein the flow cell further comprises at least one trunk line, wherein the at least one trunk line is in fluidic connection with at least one input fluidic port, and wherein the at least one trunk line is configured to direct air bubbles away from the plurality of reaction regions.

19. The nucleic acid sequencing cartridge of claim 16, wherein the flow cell comprises at least four fluidic ports.

20. The nucleic acid sequencing cartridge of claim 19, wherein the flow cell comprises at least two input fluidic ports and at least two output fluidic ports.

21. The nucleic acid sequencing cartridge of claim 16, wherein the at least two fluidic ports are independently controllable by fluidic valves.

22. The nucleic acid sequencing cartridge of claim 21, wherein the flow cell further comprises at least one trunk line, wherein the at least one trunk line is in fluidic connection with at least one input fluidic port, and wherein the at least one trunk line is configured to direct air bubbles away from the plurality of reaction regions.

23. The nucleic acid sequencing cartridge of claim 6, wherein the flow cell further comprises a physical alignment element.

24. The nucleic acid sequencing cartridge of claim 23, wherein the physical alignment element comprises a hole, a slot, or a hole and a slot.

25. The nucleic acid sequencing cartridge of claim 6, wherein the flow cell is fabricated from a material that is at least partly transparent to UV radiation.

26. The nucleic acid sequencing cartridge of claim 25, wherein the transparent material is a UV-transparent plastic.

27. The nucleic acid sequencing cartridge of claim 26, wherein the UV-transparent plastic is an acrylonitrile butadiene styrene plastic.

28. The nucleic acid sequencing cartridge of claim 6, wherein the flow cell is fabricated from a material that is at least partly transparent to UV radiation, wherein the flow cell comprises a bottom surface in contact with the multiplexed chip, and wherein the bottom surface is at least partially covered by a material that is at least partly opaque to visible light.

29. The nucleic acid sequencing cartridge of claim 28, wherein the material that is at least partly opaque to visible light is a paint, a laser engraved or embossed material, or an opaque plastic material.

30. The nucleic acid sequencing cartridge of claim 6, wherein the flow cell is attached to the multiplexed optical chip by a UV-cure adhesive.

31. A packaged nucleic acid sequencing device comprising:
a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions;
wherein the multiplexed optical chip is attached to a printed circuit board.

32. The packaged nucleic acid sequencing device of claim 31, wherein the printed circuit board comprises a connector element in electronic contact with the optical detector.

33. The packaged nucleic acid sequencing device of claim 32, wherein the connector element is an edge connector.

34. The packaged nucleic acid sequencing device of claim 32, wherein the device further comprises a non-volatile rewritable memory in electronic contact with the connector element.

35. The packaged nucleic acid sequencing device of claim 32, wherein the device further comprises a user-observable connection indicator in electronic contact with the connector element.

36. The packaged nucleic acid sequencing device of claim 35, wherein the user-observable connection indicator comprises a light-emitting diode.

37. The packaged nucleic acid sequencing device of claim 31, wherein the device comprises a plurality of multiplexed optical chips.

38. The packaged nucleic acid sequencing device of claim 37, wherein the device comprises a plurality printed circuit boards.

39. The packaged nucleic acid sequencing device of claim 31, wherein the device further comprises an electrostatic discharge protection element.

40. The packaged nucleic acid sequencing device of claim 39, wherein the electrostatic discharge protection element comprises an electrostatic discharge dissipative plastic, a metallization, or a low-resistance foam.

41. The packaged nucleic acid sequencing device of claim 31, wherein the device further comprises a thermal conductor in thermal contact with the multiplexed optical chip.

42. The packaged nucleic acid sequencing device of claim 31, wherein the device further comprises a flow cell in fluidic contact with the plurality of reaction regions on the multiplexed optical chip.

43. The packaged nucleic acid sequencing device of claim 42, wherein the flow cell comprises at least two fluidic ports.

44. The packaged nucleic acid sequencing device of claim 43, wherein the flow cell comprises at least one input fluidic port and at least one output fluidic port.

45. The packaged nucleic acid sequencing device of claim 44, wherein the flow cell further comprises at least one trunk line, wherein the at least one trunk line is in fluidic connection with at least one input fluidic port, and wherein the at least one trunk line is configured to direct air bubbles away from the plurality of reaction regions.

46. The packaged nucleic acid sequencing device of claim 43, wherein the flow cell comprises at least four fluidic ports.

47. The packaged nucleic acid sequencing device of claim 46, wherein the flow cell comprises at least two input fluidic ports and at least two output fluidic ports.

48. The packaged nucleic acid sequencing device of claim 43, wherein the at least two fluidic ports are independently controllable by fluidic valves.

49. The packaged nucleic acid sequencing device of claim 48, wherein the flow cell further comprises at least one trunk line, wherein the at least one trunk line is in fluidic connection with at least one input fluidic port, and wherein the at least one trunk line is configured to direct air bubbles away from the plurality of reaction regions.

50. The packaged nucleic acid sequencing device of claim 42, wherein the flow cell further comprises a physical alignment element.

51. The packaged nucleic acid sequencing device of claim 50, wherein the physical alignment element comprises a hole, a slot, or a hole and a slot.

52. The packaged nucleic acid sequencing device of claim 42, wherein the flow cell is fabricated from a material that is at least partly transparent to UV radiation.

53. The packaged nucleic acid sequencing device of claim 52, wherein the material is a UV-transparent plastic.

54. The packaged nucleic acid sequencing device of claim 53, wherein the UV-transparent plastic is an acrylonitrile butadiene styrene plastic.

55. The packaged nucleic acid sequencing device of claim 42, wherein the flow cell is fabricated from a material that is at least partly transparent to UV radiation, wherein the flow cell comprises a bottom surface in contact with the multiplexed optical chip, and wherein the bottom surface is at least partially covered by a material that is at least partly opaque to visible light.

56. The packaged nucleic acid sequencing device of claim 55, wherein the material that is at least partly opaque to visible light is a paint, a laser engraved or embossed material, or an opaque plastic material.

57. The packaged nucleic acid sequencing device of claim 42, wherein the flow cell is attached to the multiplexed optical chip by a UV-cure adhesive.

58. A packaged nucleic acid sequencing device comprising:
a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions; and
a flow cell in fluidic connection with the plurality of reaction regions on the multiplexed optical chip.

59. The packaged nucleic acid sequencing device of claim 58, wherein the flow cell comprises at least two fluidic ports.

60. The packaged nucleic acid sequencing device of claim 59, wherein the flow cell comprises at least one input fluidic port and at least one output fluidic port.

61. The packaged nucleic acid sequencing device of claim 60, wherein the flow cell further comprises at least one trunk line, wherein the at least one trunk line is in fluidic connection with at least one input fluidic port, and wherein the at least one trunk line is configured to direct air bubbles away from the plurality of reaction regions.

62. The packaged nucleic acid sequencing device of claim 59, wherein the flow cell comprises at least four fluidic ports.

63. The packaged nucleic acid sequencing device of claim 62, wherein the flow cell comprises at least two input fluidic ports and at least two output fluidic ports.

64. The packaged nucleic acid sequencing device of claim 59, wherein the at least two fluidic ports are independently controllable by fluidic valves.

65. The packaged nucleic acid sequencing device of claim 64, wherein the flow cell further comprises at least one trunk line, wherein the at least one trunk line is in fluidic connection with at least one input fluidic port, and wherein the at least one trunk line is configured to direct air bubbles away from the plurality of reaction regions.

66. The packaged nucleic acid sequencing device of claim 58, wherein the flow cell further comprises a physical alignment element.

67. The packaged nucleic acid sequencing device of claim 66, wherein the physical alignment element comprises a hole, a slot, or a hole and a slot.

68. The packaged nucleic acid sequencing device of claim 58, wherein the flow cell is fabricated from a material that is at least partly transparent to UV radiation.

69. The packaged nucleic acid sequencing device of claim 68, wherein the material is a UV-transparent plastic.

70. The packaged nucleic acid sequencing device of claim 69, wherein the UV-transparent plastic is an acrylonitrile butadiene styrene plastic.

71. The packaged nucleic acid sequencing device of claim 58, wherein the flow cell is fabricated from a material that is at least partly transparent to UV radiation, wherein the flow cell comprises a bottom surface in contact with the multiplexed chip, and wherein the bottom surface is at least partially covered by a material that is at least partly opaque to visible light.

72. The packaged nucleic acid sequencing device of claim 71, wherein the material that is at least partly opaque to visible light is a paint, a laser engraved or embossed material, or an opaque plastic material.

73. The packaged nucleic acid sequencing device of claim 58, wherein the flow cell is attached to the multiplexed optical chip by a UV-cure adhesive.

74. The packaged nucleic acid sequencing device of claim 58, wherein the multiplexed optical chip is attached to a printed circuit board.

75. The packaged nucleic acid sequencing device of claim 74, wherein the printed circuit board comprises a connector element in electronic contact with the optical detector.

76. The packaged nucleic acid sequencing device of claim 75, wherein the connector element is an edge connector.

77. The packaged nucleic acid sequencing device of claim 75, wherein the device further comprises a non-volatile rewritable memory in electronic contact with the connector element.

78. The packaged nucleic acid sequencing device of claim 75, wherein the device further comprises a user-observable connection indicator in electronic contact with the connector element.

79. The packaged nucleic acid sequencing device of claim 78, wherein the user-observable connection indicator comprises a light-emitting diode.

80. The packaged nucleic acid sequencing device of claim 74, wherein the device further comprises an electrostatic discharge protection element.

81. The packaged nucleic acid sequencing device of claim 80, wherein the electrostatic discharge protection element comprises an electrostatic discharge dissipative plastic, a metallization, or a low-resistance foam.

82. The packaged nucleic acid sequencing device of claim 74, wherein the device further comprises a thermal conductor in thermal contact with the multiplexed optical chip.

83. The packaged nucleic acid sequencing device of claim 58, wherein the multiplexed optical chip is surrounded by a protective enclosure.

84. The packaged nucleic acid sequencing device of claim 83, wherein the device further comprises a connector element in electronic contact with the optical detector.

85. The packaged nucleic acid sequencing device of claim 84, wherein the protective enclosure comprises at least one aperture for access to the connector element.

86. The packaged nucleic acid sequencing device of claim 83, wherein the device further comprises a thermal conductor in thermal contact with the multiplexed optical chip.

87. The packaged nucleic acid sequencing device of claim 86, wherein the protective enclosure comprises at least one aperture for access to the thermal conductor.

88. The packaged nucleic acid sequencing device of claim 83, wherein the protective enclosure comprises at least one aperture for access to the flow cell.

89. The packaged nucleic acid sequencing device of claim 88, wherein the at least one aperture is covered by a retractable protective shield.

90. The packaged nucleic acid sequencing device of claim 83, wherein the protective enclosure comprises an ejection pin on an external surface of the protective enclosure, wherein the ejection pin is configured for reversible association with an optical sequencing system.

91. A system for optical analysis, the system comprising:
an optical source;
a nucleic acid sequencing cartridge comprising:
a multiplexed optical chip comprising;
a plurality of reaction regions;
at least one optical waveguide optically coupled to the plurality of reaction regions;
an optical coupler optically coupled to the at least one optical waveguide; and
an optical detector optically coupled to the plurality of reaction regions; and
a flow cell in fluidic connection with the plurality of reaction regions on the multiplexed optical chip;
wherein the multiplexed optical chip is attached to a printed circuit board; and
wherein the multiplexed optical chip and the printed circuit board are surrounded by a protective enclosure.

92. The system of claim 91, wherein the flow cell comprises at least two fluidic ports.

93. The system of claim 92, wherein the flow cell comprises at least one input fluidic port and at least one output fluidic port.

94. The system of claim 93, wherein the flow cell further comprises at least one trunk line, wherein the at least one trunk line is in fluidic connection with at least one input fluidic port, and wherein the at least one trunk line is configured to direct air bubbles away from the plurality of reaction regions.

95. The system of claim 92, wherein the flow cell comprises at least four fluidic ports.

96. The system of claim 95, wherein the flow cell comprises at least two input fluidic ports and at least two output fluidic ports.

97. The system of claim 92, wherein the at least two fluidic ports are independently controllable by fluidic valves.

98. The system of claim 97, wherein the flow cell further comprises at least one trunk line, wherein the at least one trunk line is in fluidic connection with at least one input fluidic port, and wherein the at least one trunk line is configured to direct air bubbles away from the plurality of reaction regions.

99. The system of claim 91, wherein the flow cell further comprises a physical alignment element.

100. The system of claim 99, wherein the physical alignment element comprises a hole, a slot, or a hole and a slot.

101. The system of claim 91, wherein the flow cell is fabricated from a material that is at least partly transparent to UV radiation.

102. The system of claim 101, wherein the material is a UV-transparent plastic.

103. The system of claim 102, wherein the UV-transparent plastic is an acrylonitrile butadiene styrene plastic.

104. The system of claim 91, wherein the flow cell is fabricated from a material that is at least partly transparent to UV radiation, wherein the flow cell comprises a bottom surface in contact with the multiplexed chip, and wherein the bottom surface is at least partially covered by a material that is at least partly opaque to visible light.

105. The system of claim 104, wherein the material that is at least partly opaque to visible light is a paint, a laser engraved or embossed material, or an opaque plastic material.

106. The system of claim 91, wherein the flow cell is attached to the multiplexed optical chip by a UV-cure adhesive.

107. The system of claim 91, wherein the system further comprises a beam dump.

108. The system of claim 91, wherein the system further comprises a fluidic clamp.

109. The system of claim 108, wherein the fluidic clamp comprises a plurality of clamping ports in fluidic connection with the flow cell.

110. The system of claim 108, wherein the system further comprises a syringe pump in fluidic connection with the fluidic clamp.

111. The system of claim 108, wherein the fluidic clamp is driven by a cam mechanism.

112. The system of claim 111, wherein the cam mechanism is driven by a stepper motor.

113. The system of claim 108, wherein the fluidic clamp comprises a beam dump.

114. The system of claim 113, wherein the beam dump captures excess optical energy from the optical source and converts the excess optical energy to heat.

115. The system of claim 91, wherein the optical source is replaceable by a user.

116. The system of claim 91, wherein the optical source is configured to emit an optical excitation beam, and wherein the optical excitation beam is coupled to the optical coupler.

117. The system of claim 116, wherein the system is configured to move either the multiplexed optical chip or the optical excitation beam to maximize an optical alignment signal.

118. The system of claim 117, wherein either the multiplexed optical chip or the optical excitation beam is movable in at least two dimensions.

119. The system of claim 116, wherein the system does not include an alignment camera.

120. The system of claim 116, wherein the multiplexed optical chip comprises at least one alignment feature at a defined location on the multiplexed optical chip.

121. The system of claim 120, wherein the defined location of the at least one alignment feature is stored in a non-volatile rewritable memory.

122. The system of claim 91, wherein the system further comprises a cooling system in thermal contact with the multiplexed optical chip.

123. The system of claim 122, wherein the cooling system comprises an air blower.

124. The system of claim 122, wherein the cooling system comprises a thermoelectric cooler.

125. The system of claim 91, wherein the multiplexed optical chip comprises at least 2, at least 5, at least 10, at least 50, at least 100, at least 500, at least 1,000, at least 5,000, at least 10,000, or at least 50,000 optical waveguides.

126. The system of claim 91, wherein the multiplexed optical chip comprises no more than 100,000, no more than 50,000, no more than 10,000, no more than 5,000, no more than 1,000, no more than 500, or no more than 100 optical waveguides.

127. The system of claim 91, wherein the multiplexed optical chip comprises from 1 to 100,000, from 100 to 10,000, or from 500 to 5,000 optical waveguides.

128. The system of claim 91, further comprising a computer that receives at least one electronic signal from the optical detector and analyzes the at least one electronic signal.

129. The system of claim 128, wherein the analysis comprises obtaining nucleic acid sequencing information.

130. The system of claim 91, wherein the optical source has a wavelength of excitation from about 450 nm to about 700 nm or from about 500 nm to about 650 nm.

131. The system of claim 91, wherein the multiplexed optical chip is fabricated on a silicon chip.

132. The system of claim 91, wherein the optical detector comprises a CMOS sensor.

133. The system of claim 91, wherein the plurality of reaction regions comprises a plurality of nucleic acid samples.

134. The system of claim 91, wherein the plurality of reaction regions comprises a plurality of nanoscale wells.

135. The system of claim 91, wherein the plurality of reaction regions comprises a plurality of zero mode waveguides.
